(19) United States
(12) Patent Application Publication
(10) Pub. No.: US 2013/0254125 A1
(43) Pub. Date: Sep. 26, 2013

(54) Remote Execution of and Transfer of Rights in Registered Applications

(71) Applicant: VideoiGames, Inc., Cherry Hill, NJ (US)

(72) Inventor: Daymeon L. Sanders, Willingboro, NJ (US)

(73) Assignee: VideoiGames, Inc., Cherry Hill, NJ (US)

(21) Appl. No.: 13/904,087

(22) Filed: May 29, 2013

Related U.S. Application Data
(63) Continuation-in-part of application No. 13/341,050, filed on Dec. 30, 2011.

(51) Int. Cl. H04L 29/06

(52) U.S. Cl. CPC H04L 63/08
USPC 705/310; 726/4

(57) ABSTRACT

A computer system enables a computing device to execute a registered software application even though the registered software application is not registered to the computing device. The computing device is capable of streaming the registered software application to multiple other computing devices, including the computing device to which the registered software application is registered and computing devices to which the registered software application is not registered. The computer system also enables registered software applications to be exchanged among users.

### CROSS REFERENCE TO RELATED APPLICATIONS

This application is a continuation-in-part of U.S. patent application Ser. No. 13/341,050, filed on Dec. 30, 2011, entitled “Method, System and Program Product for Operation and Management of Applications,” which is hereby incorporated by reference.

### BACKGROUND

Many commercial software vendors employ registration systems, according to which each instance of a software application sold by the vendor must be installed and registered to a particular computer before the application instance can be executed (or for the application to be executed beyond a trial period of, for example, one month). As part of the process of registering a particular instance of a particular software application, the particular instance of the software application often transmits its unique license key and a unique identifier of the computer on which it is installed (such as the IP address of that computer) to a server maintained by the software vendor, thereby linking the unique license key to the unique identifier. Each time the application instance is launched, the application instance connects to the vendor's license server, and transmits to the license server the application instance's license key and the unique identifier of the computer on which the application instance is executing. In response to receiving such data, the vendor's license server compares the received license key and unique identifier pair to the license key and unique identifier pair that were previously registered with the license server. If the two pairs do not match, the license server prevents the application instance from executing. Such a system is intended by the software vendor to prohibit unauthorized copies of the application instance from being installed and executed on more than one computer. Although various such systems exist, most such systems share the same general features as those just described.

Such systems have a variety of drawbacks. For example, they make it difficult to install multiple copies of the same application instance on multiple computing devices. Although such systems are designed precisely to prevent such installation and execution of multiple copies of the same application instance in order to prevent copyright infringement and breach of end user license agreements, users may have legitimate reasons for making such multiple copies.

### SUMMARY

A computer system enables a computing device to execute a registered software application even though the registered software application is not registered to the computing device. The computing device is capable of streaming the registered software application to multiple other computing devices, including the computing device to which the registered software application is registered and computing devices to which the registered software application is not registered. The computer system also enables registered software applications to be exchanged among users.

For example, one embodiment of the present invention is directed to a method comprising: (1) providing, to a registration server, a first request to authorize a first application instance installed on, but not registered to, a first computing device to execute on the first computing device; (2) receiving, from the registration server, in response to the request, a response authorizing the first application instance to execute on the first computing device; and (3) executing the first application instance on the first computing device.

Other features and advantages of various aspects and embodiments of the present invention will become apparent from the following description and from the claims.

### BRIEF DESCRIPTION OF THE DRAWINGS

FIG. 1A is a dataflow diagram of a system for registering an instance of a software application with a registration server according to one embodiment of the present invention;

FIG. 1B is a dataflow diagram of a system for executing a registered application instance on a computing device according to one embodiment of the present invention;

FIG. 2A is a flowchart of a method performed by the system of FIG. 1A according to one embodiment of the present invention;

FIG. 2B is a flowchart of a method performed by the system of FIG. 1B according to one embodiment of the present invention;

FIG. 3 is a dataflow diagram of a system for creating a record of a application instance and of the computing device to which the application instance is registered according to one embodiment of the present invention;

FIG. 4 is a flowchart of a method performed by the system of FIG. 3 according to one embodiment of the present invention;

FIG. 5 is a dataflow diagram of a system for streaming an application instance to one or more computing devices according to one embodiment of the present invention;

FIG. 6 is a flowchart of a method performed by the system of FIG. 5 according to one embodiment of the present invention;

FIG. 7 is a dataflow diagram of a system for enabling one user to sell an application instance to a second user according to one embodiment of the present invention;

FIG. 8 is a flowchart of a method performed by the system of FIG. 7 according to one embodiment of the present invention;

FIG. 9 is a dataflow diagram of a system for enabling one user to swap a first application instance with a second user in exchange for a second application instance according to one embodiment of the present invention;

FIG. 10 is a flowchart of a method performed by the system 90 of FIG. 9 according to one embodiment of the present invention;

FIG. 11 is a dataflow diagram of a system for enabling one user to switch an application instance to a second user according to one embodiment of the present invention;

FIG. 12 is a flowchart of a method performed by the system of FIG. 11 according to one embodiment of the present invention;

FIG. 13 is a dataflow diagram of a system for measuring application instance usage according to one embodiment of the present invention; and

FIG. 14 is a flowchart of a method performed by the system of FIG. 13 according to one embodiment of the present invention.

### DETAILED DESCRIPTION

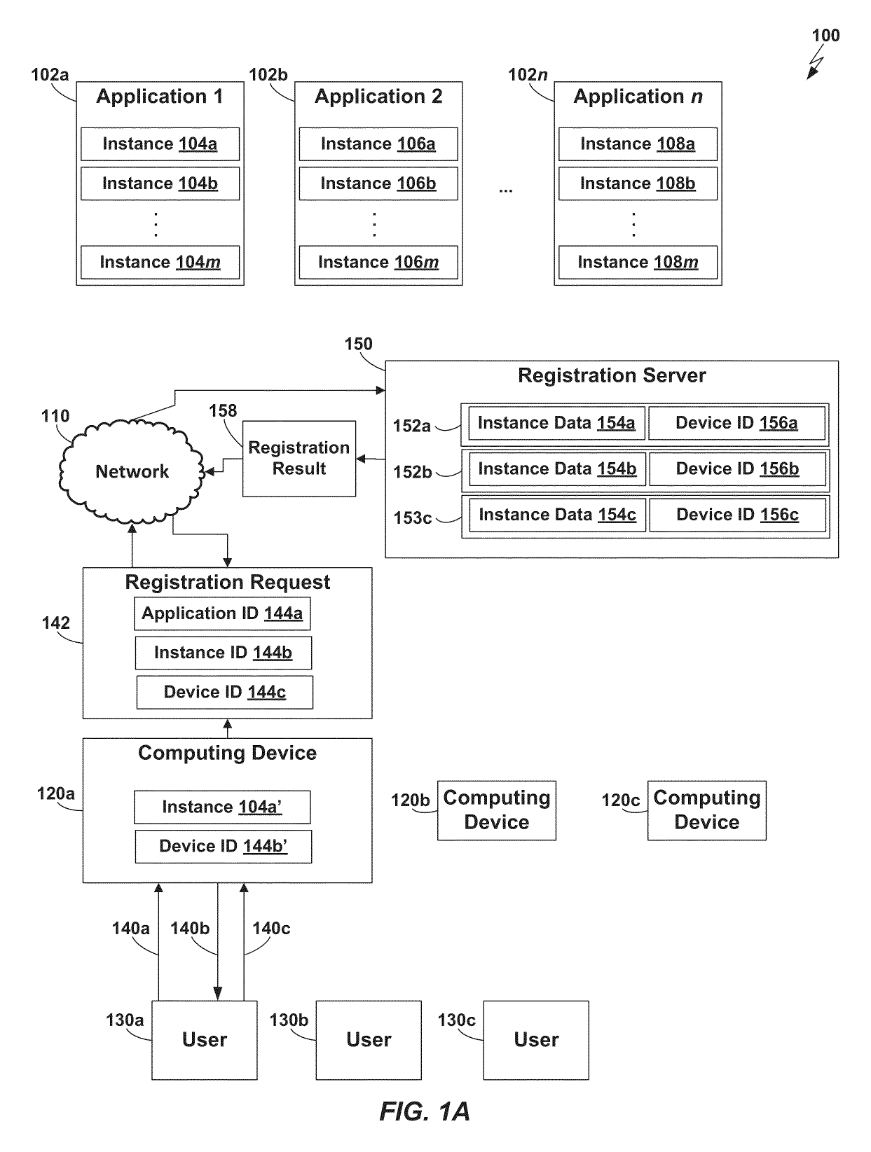

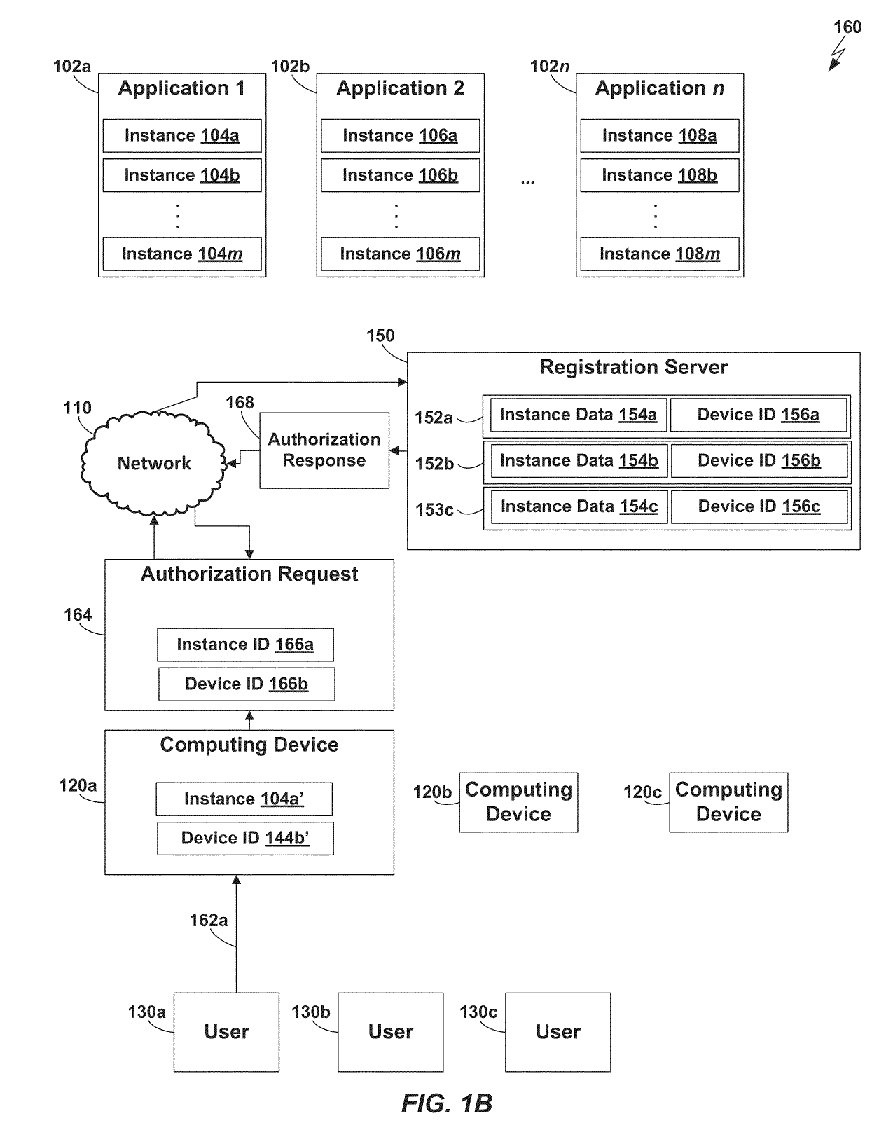

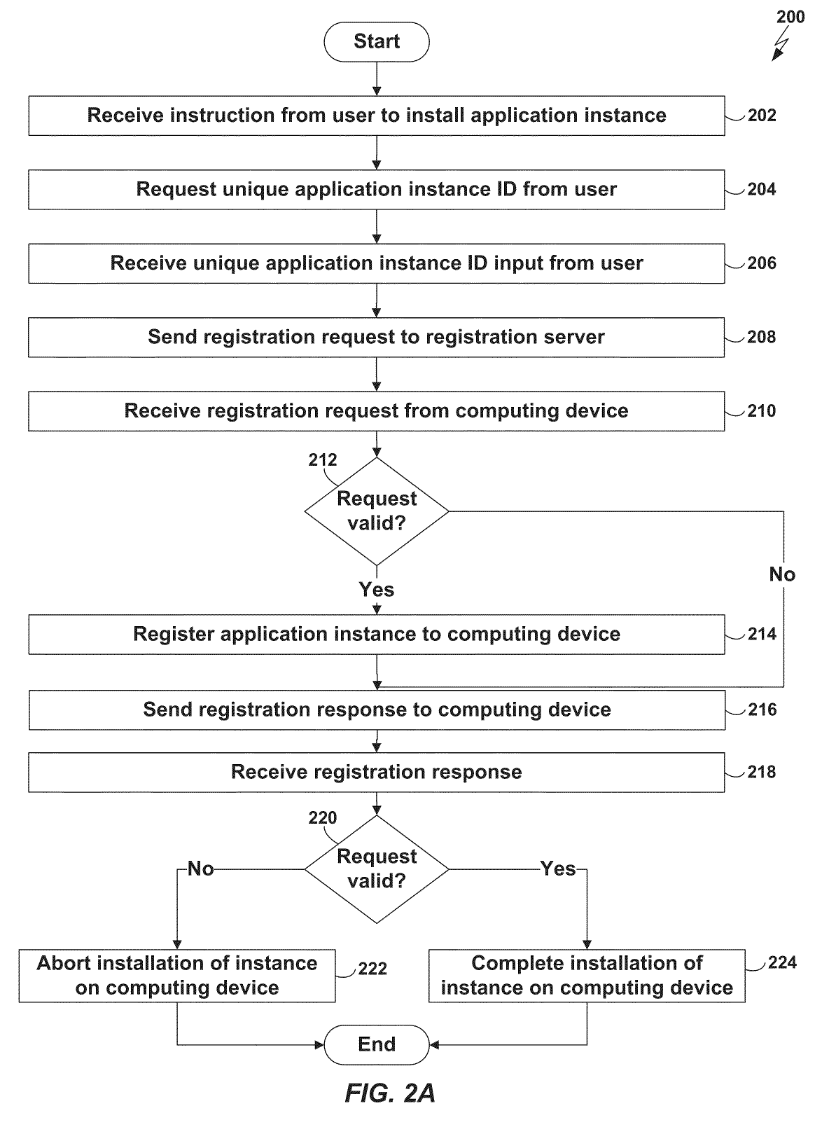

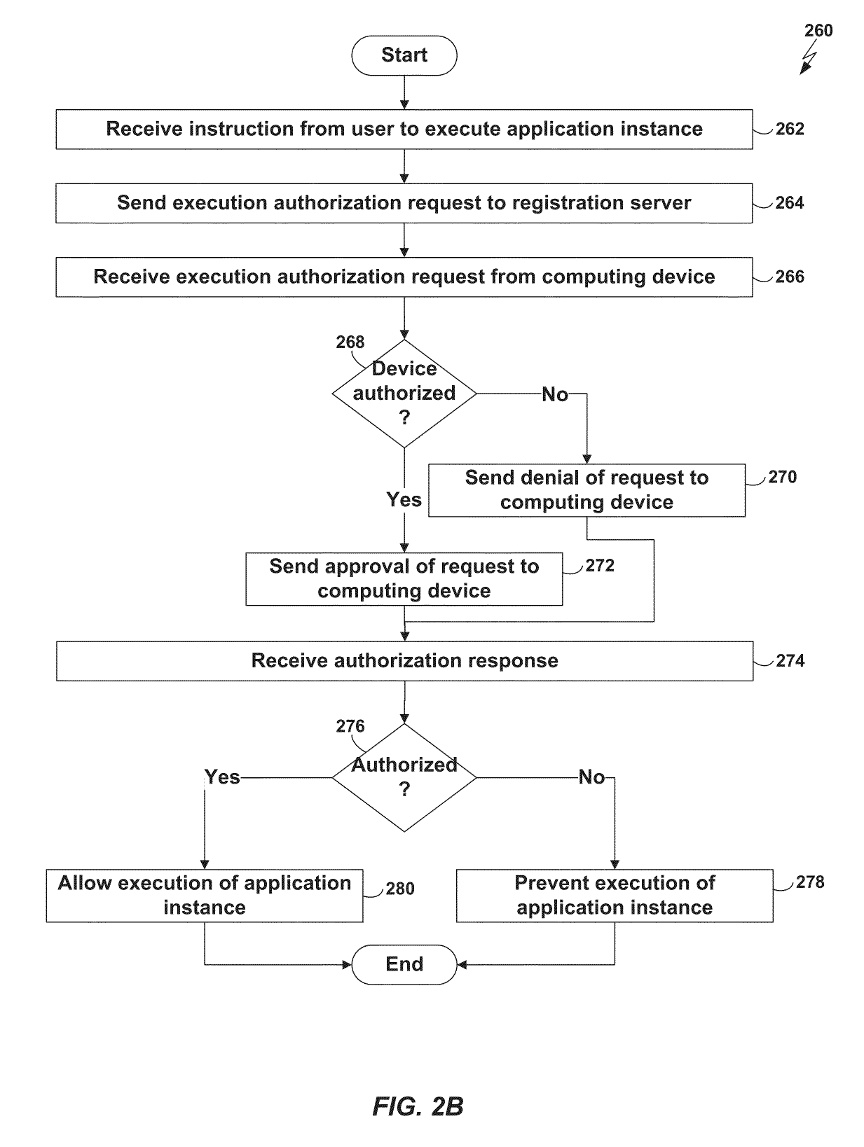

Referring to FIG. 1A, a dataflow diagram is shown of a system 100 for registering an instance of a software application with a registration server 150 according to one embodiment of the present invention. Referring to FIG. 2A, a flowchart is shown of a method 200 performed by the system 100 of FIG. 1A according to one embodiment of the present invention.

Before describing the system 100 and method 200 in detail, certain terms as used herein will be defined. The terms “software,” “software application,” and “application” are used interchangeably herein to refer to any computer program. For example, certain embodiments of the present invention may be used in connection with videogame software applications, although this is merely an example and does not constitute a limitation of the present invention. In other words, software applications that are not videogames are examples of “software applications,” as that term is used herein. World of Warcraft, Bioshock Infinite, and Assassins Creed III are all examples of software applications, as are Microsoft Word 2012, FireFox 20.0, and Apple Mail 6.3. Different versions of an application, such as Apple Mail 6.2 and Apple Mail 6.3, may be considered to be different software applications or the same software application.

Although in conventional usage, the term “application” sometimes refers only to some types of computer programs, such as word processing applications and spreadsheet applications, and not to other types of computer programs, such as operating systems and device drivers, the term “application” as used herein includes any kind of computer program, without limitation.

There may be multiple “instances” of a particular software application. Two instances of a particular software application may, for example, be two copies of the particular software application, such as a first copy of the particular software application stored on a first non-transitory computer-readable medium (e.g., a first DVD, a first memory (e.g., ROM or RAM), or a first storage device) and a second copy of the particular software application stored on a second non-transitory computer-readable medium (e.g., a second DVD or a second storage device). Consider, for example, two DVDs of the same version of Microsoft Word. The software on the first DVD constitutes a first instance of the Microsoft Word application, and the software on the second DVD constitutes a second instance of the Microsoft Word application.

Each instance of a particular software application is associated with an identifier that is unique among all instances of the particular software application. Such an identifier is referred to herein as a “unique identifier” or “unique ID” of the application instance. An example of a unique ID is a license key. For example, each of a plurality of instances of a particular software application may be associated with an identifier that is unique among all of the identifiers associated with the plurality of instances of the particular software application. As a very simple example, three instances of Microsoft Word may be associated with unique IDs 123, 456, and 789, respectively. Unique identifiers may take any form and may be generated in any of a variety of ways, as is well-known to those having ordinary skill in the art.

As is implied by the discussion above, the identifiers for an instance of a first software application (e.g., Microsoft Word 2012) and a second software application (e.g., Firefox 20.0) may be the same as or different than each other. Software vendors typically issue instances of an application such that no two instances of the same application have the same unique ID as each other. Two instances of the same application may, however, have the same unique ID as each other if, for example, a user copies an instance of an application, thereby creating two instances having the same unique ID. The term “unique ID,” as used herein, therefore, may not always refer to an ID that is unique across all instances of an application.

Referring again to FIG. 1A, the system 100 includes a plurality of software applications 102a-n. Although three software applications 102a, 102b, and 102n are shown in FIG. 1A for ease of illustration, this is merely an example and does not constitute a limitation of the present invention. More generally, the system 100 may include any number of software applications (i.e., n may be any number). Furthermore, each of the software applications 102a-n may be any kind of software application, in any combination. For example, any one or more of the software applications 102a-n may be a videogame software application.

Each of the software applications 102a-n includes one or more instances of that application. In particular, application 102a includes instances 104a-m, application 102b includes instances 106a-m, and application 102n includes instances 108a-m. Each application may include any number of instances. For example, although each of the applications 102a-n is shown in FIG. 1A as including m instances, the number of instances may vary from application to application.

As described above, an application instances may, for example, be or include a copy of the application stored on a computer-readable medium. Any two instances of the same application may be stored on the same or different computer-readable medium as each other. For example, instance 104a and 104b of application 102a may be stored on the same computer-readable medium as each other, or on different computer-readable media than each other. The same is true across applications 102a-n. For example, instance 104a of application 102a may be stored on the same computer readable medium as, or a different computer-readable medium than, instance 106a of application 102b.

Referring now both to FIG. 1A and FIG. 2A, techniques for installing and registering a particular application instance on a particular computing device will be described. Consider an example in which a user 130a desires to install instance 104a on a computing device 120a. As will be described in more detail below, the user 130a may own or otherwise have access to a plurality of computing devices 120a-c, each of which may be any kind of computing device in any combination. Examples of such kinds of computing devices include desktop computers, laptop computers, tablet computers, smartphones, and videogame consoles. Although only three computing devices 120a-c are shown in FIG. 1A for ease of illustration, the user 130a may own or otherwise have access to any number of computing devices.

The computing device 120a receives an instruction 140a from the user 130a to install the application instance 104a on the computing device 120a. The instruction 140a may take any of a variety of forms. For example, the user 130a may issue the instruction by:
inserting a computer-readable medium (e.g., DVD), which may contains some or all of the application instance 104a, into a storage device within or otherwise connected to the computing device 120a;
downloading some or all of the application instance 104a over a network 110 (e.g., the public Internet or a private intranet) onto the computing device 120a, and possibly issuing an additional command to install the application instance 104a (e.g., by double-clicking on a visual representation of the application instance 104a);
downloading an application installation application associated with the application instance 104a over the network 110 onto the computing device 120a;
using an input device to click on a button or other user interface element in another software application instance (not shown) executing on the computing device 120a, such as a user interface element within a web page displayed by a web browser executing on the computing device 120a.

In any of the examples above, the user 130a may provide additional inputs as part of providing the instruction 140a to install the application instance 104a, such as double-clicking on an icon or other visual representation of the application instance 104a, or by clicking on a “run” button. The list above merely represents example of ways in which the user 130a may issue the installation instruction 140a and does not constitute a limitation of the present invention. Regardless of the form that the request 140a takes, the request 140a identifies the application instance 104a to be installed.

In response to receiving the installation request 140a, the computing device 120a provides to the user 130a a request 140b for a unique identifier associated with the application instance 104a to be installed (FIG. 2A, operation 204). The request 140b may take any of a variety of forms. For example, the request 140b may take the form of a textual prompt, such as “Enter license key:”.

In response to the request 140b, the user 130a provides input 140c representing what the user purports to be the unique identifier (e.g., license key) associated with the application instance 104a. The computing device 120a receives the unique ID input 140c from the user (FIG. 2A, operation 206).

The user 130a may obtain data to include in the unique ID input 140c in any of a variety of ways. For example, if the user obtained the application instance 104a on a physical storage medium, then the unique ID associated with the application instance may be printed on the physical storage medium or otherwise be contained within the same packaging as the physical storage medium, in which case the user 130a may manually copy the unique ID into the unique ID input 140c. As another example, if the user 130a purchased or otherwise obtained the application instance online 104a, then the user 130a may have received the unique ID associated with the application instance 104a in an email message, a web page, or other electronic notification, in which case the user 130a may copy (e.g., cut and paste) the unique ID from the electronic notification into the unique ID input 140c.

The unique ID input 140c may or may not represent the unique ID associated with the instance 104a. The unique ID input 140c may not represent the unique ID associated with the instance 104a if, for example, the user 130a mistypes, misremembers, or otherwise mistakenly enters the unique ID associated with the application instance 104a. As another example, the user 130a may not have access to the unique ID associated with the application instance 104a, in which case the user 130a may provide the incorrect license key in the input 140c, e.g., in an attempt to fraudulently install the application instance 104a on the computing device 120a.

The system 100 may use any of a variety of well-known techniques to determine whether the unique ID input 140c provided by the user 130a represents the unique ID associated with the instance 104a, and to allow the user 140c to install or otherwise execute the application instance 104a on the computing device 120a only if the unique ID input 140c represents the unique ID associated with the application instance 104a.

For example, the computing device 120a may transmit a registration request 142 to a registration server 150 over the network 110 (FIG. 2A, operation 208). The registration request 142 may contain any of a variety of data, examples of which are one or more of the following:
an application identifier 144a, which identifies the application 102a of which the application instance 104a is an instance;
a unique identifier 144b, which may be data that is a copy of or otherwise derived from the unique ID input 140c received from the user 140c; and
a computing device identifier 144c, which may be any data that uniquely identifies the computing device 120a, such as an Internet Protocol (IP) address of the computing device 120a.

The registration server 150 receives the registration request 142 from the computing device 120a over the network 110 (FIG. 2A, operation 210). In general, the registration server 150 creates, maintains, and serves information representing registration of application instances to computing devices. In response to receiving the registration request 142, the registration server 150 may determine whether the unique ID data 144b represents a valid unique ID for the application represented by the application ID data 144a (FIG. 2A, operation 212). The registration server 150 may make the determination of operation 212 in any of a variety of ways. For example:
The registration server 150 may contain or otherwise have access to a list (not shown) of valid unique IDs associated with the application 102a represented by the application ID data 144a. Such a list of valid unique IDs may, for example, include unique IDs that are associated with the application 102a and which have not yet been registered to any computing devices. The registration server 150 may determine whether the registration request 142 is valid by determining whether the unique ID data 144b in the registration request 142 represents a unique ID in the list of valid unique IDs associated with the application represented by the application ID data 144a.
The registration server 150 may determine whether the registration request 142 is valid by applying a formula or other algorithm to some or all of the registration request 142 (e.g., the application ID 144a and/or unique ID 144b).
The registration request 142 may further include a valid unique ID (not shown) associated with the application instance 104a. For example, the computing device 120a may copy such a predetermined valid unique ID from the physical storage medium on which the application instance 104a is stored and/or from the installation executable file for the application instance 104a, without revealing the predetermined valid unique ID to the user 130a. The registration server 150 may determine whether the registration request 142 is valid by determining whether the unique ID 144b provided by the computing device 120a is the same as or otherwise equivalent to the predetermined valid unique ID in the registration request 142.

If the registration server 150 determines that the registration request 142 is valid, then the registration server 150 registers the application instance 104a to the computing device 120a (FIG. 2A, operation 214). Otherwise, the registration server 150 does not register the application instance 104a to the computing device 120a.

To register the application instance 104a to the computing device 120a, the registration server 150 may, for example, create and store a record indicating that the application instance 104a is associated with (e.g., registered to) the computing device 120a. For example, the registration server 150 may create and store a registration record 152a, which includes: (1) application instance data 154a, which identifies the application instance 104a; and (2) computing device ID data, which identifies the computing device 120a. As a result, the registration record 152a indicates that the application instance 104a is registered to the computing device 120a.

The application instance data 154a may take any of a variety of forms. For example, the application instance data 154a may include one or both of the application ID 144a and the unique ID 144b contained in the registration request 142.

The computing device ID 156a may take any of a variety of forms. For example, the computing device ID 156a may include the computing device ID 144c from the registration request 142.

Whether or not the registration request 142 is valid, the registration server 150 may transmit a registration result message 158 to the computing device 120a over the network 110 (FIG. 2A, operation 216). In general, the registration result message 158 indicates whether the registration succeeded (i.e., whether the registration request 142 was valid) or failed (i.e., whether the registration request 142 was invalid). The registration result message 158 may include additional data, such as data required by the computing device 120a to unlock or otherwise execute the application instance 104a on the computing device 120a.

The computing device 120a receives the registration result message 158 (FIG. 2A, operation 218). In response to receiving the registration result message 158, the computing device 120a determines whether the registration result message 158 indicates that the application instance 104a has been registered to the computing device 120a (e.g., that the registration request 142 was valid) (FIG. 2A, operation 220).

If the computing device 120a determines that the application instance 104a has not been registered to the computing device 120a, then the computing device 120a aborts the installation and registration of the application instance 104a (FIG. 2A, operation 222). Aborting the installation and registration may include, for example, removing any installation files, temporary data, and other data associated with the application instance 104a from the computing device 120a.

If the computing device 120a determines that the application instance 104a has been registered to the computing device 120a, then the computing device 120a completes the installation of the application instance 104a on the computing device 120a in a manner that enables the application instance 104a to be executed on the computing device 120a (FIG. 2A, operation 224). Completion of the installation of the application instance 104a on the computing device 120a may include any one or more of the following:
initiating installation of the application instance 104a on the computing device 120a if such installation was not initiated before registering the application instance 104a to the computing device 120a, and completing such installation;
completing installation of the application instance 104a on the computing device 120a if such installation was initiated before registering the application instance 104a to the computing device 120a; and
storing, on the computing device 120a and/or a storage medium accessible to the computing device 120a, data necessary to execute the application instance 104a on the computing device 120a (such as some or all of the data contained in the registration request 142 and/or registration result message 158).

For example, as a result of installing the application instance 104a on the computing device 104a and registering the application instance 104a to the computing device 104a, the computing device 120a may contain or otherwise have access to: (1) a copy 104a′ of application instance 104a (or data derived therefrom, such as an installed version of application instance 104a resulting from running an installation executable program for application instance 104a); and (2) a copy 144b′ of the unique ID 144b associated with the application instance 104a.

The registration server 150 may include or otherwise have access to registration records in addition to the registration record 152a described above. For purposes of example, FIG. 1A shows the registration server 150 as containing or otherwise having access to three registration records 152a-c, each of which may have the properties described above for the registration record 152, but in connection with distinct application instances. Although three registration records 152a-c are shown in FIG. 1A for ease of illustration, the registration server 150 may contain any number of registration records.

In general, each of the registration records 152a-c contains data representing the registration of a particular application instance to a particular computing device. The registration records 152a-c may be implemented in any of a variety of ways. For example, each of the registration records may include: (1) application instance data representing the application instance associated with the registration record; and (2) computing device identifier (ID) data representing the computing device to which the application instance is registered. More specifically, in the example of FIG. 1A:
registration record 152a includes application instance data 154a, representing a first application instance (e.g., application instance 104a), and computing device ID data 156a representing a computing device (e.g., computing device 120a) to which the first application instance is registered;
registration record 152b includes application instance data 154b, representing a second application instance, and computing device ID data 156b representing a computing device to which the second application instance is registered; and
registration record 152c includes application instance data 154c, representing a third application instance, and computing device ID data 156c representing a computing device to which the third application instance is registered.

The registration records 152a-c may indicate that any number of application instances are registered to any particular computing device. For example, the registration records 152a-c may indicate that zero, one, or more application instances are registered to computing device 120a.

Although the techniques illustrated in FIGS. 1A-1B and 2A-2B are described above as being applied to the request 142 to register application instance 104a to computing device 120a, the same techniques may be applied to any request to register any of the application instances 104a-m, 106a-m, and 108a-m to any of the computing devices 120a-c and/or to other computing devices (not shown). Such registration requests, if successful, may result in the creation and/or modification of the registration records 152a-c in the registration server 150.

Although certain operations in method 200 are described as being performed by the computing device 120a and certain operations are described as being performed by the registration server 150, these are merely examples and do not constitute limitations of the present invention. Any operation of method 200 may be performed by the computing device 120a, registration server 150, or a combination thereof. Those having ordinary skill in the art will understand how to modify method 200 accordingly. For example, the computing device 120a need not transmit the registration request 142 to the registration server 150, but may instead determine whether the registration request 142 is valid, and then transmit the registration result message 158 to the registration server 150 to indicate to the registration server 150 whether the registration request 142 is valid.

If the method 200 results in the application instance 104a being registered to the computing device 120a, then the user 130a may subsequently execute the application instance 104a′ on the computing device 120a. Referring to FIG. 1B, a dataflow diagram is shown of a system 160 for executing the application instance 104a′ on the computing device according to one embodiment of the present invention. Referring to FIG. 2B, a flowchart is shown of a method 260 performed by the system 160 of FIG. 1B according to one embodiment of the present invention.

The user 130a provides execution input 162a to the computing device 120a (FIG. 2B, operation 262). The input 162a represents an instruction to execute the application instance 104a′ on the computing device 120a. In response to receiving the instruction 162a, the computing device 120a transmits an execution authorization request 164 to the registration server 150 over the network 110 (FIG. 2B, operation 264). In general, the execution authorization request 164 contains data representing a request to execute the application instance 104a′ on the computing device 120a. The execution authorization request 164 may take any of a variety of forms. For example, the execution authorization request 164 may include one or both of: (1) unique ID data 166a, such as a copy of the unique ID data 144b′ stored at the computing device 120a in association with the application instance 104a′; and (2) a computing device ID 166, such as the current IP address and/or MAC address of the computing device 120a.

The registration server 150 receives the execution authorization request 164 (FIG. 2B, operation 266). In response to receiving the request 164, the registration server 150 determines whether the application instance 104a′ is authorized to execute on the computing device 120a (e.g., whether the application instance 104a′ is registered to the computing device 120a) (FIG. 2B, operation 268). In response to determining whether the application instance 104a′ is authorized to execute on the computing device 120a, the registration server 150 transmits to the computing device 120a an authorization response 168 indicating whether the application instance 104a′ is authorized to execute on the computing device 120a (FIG. 2B, operations 270 and 272). More specifically, if the registration server 150 determines that the application instance 104a is not authorized to execute on the computing device 120a, then the registration server 150 includes, in the authorization response 168, data indicating that the application instance 104a is not authorized to execute on the computing device 120a (FIG. 2B, operation 270). Conversely, if the registration server 150 determines that the application instance 104a is authorized to execute on the computing device 120a, then the registration server 150 includes, in the authorization response 168, data indicating that the application instance 104a is authorized to execute on the computing device 120a (FIG. 2B, operation 272).

The registration server 150 may determine whether the application instance 104a is authorized to execute on the computing device 120a in any of a variety of ways. In general, the registration server 150 may determine whether the application instance 104a is authorized to execute on the computing device 120a by comparing some or all of the data in the authorization request 164 to some or all of the data in the registration record 152a associated with the application instance 104a′. For example, the registration server 150 may locate the registration record 152a that is associated with the application instance 104a′ by searching the application instance data 154a-c for a unique application instance ID that matches the unique application instance ID 166a in the authorization request 164. If the registration server 150 finds such a matching registration record, the registration server 150 may determine whether the computing device ID 166b in the authorization request 164 matches the computing device ID 156a in the matching registration record 152a. The registration server 150 may conclude that the application instance 104a is authorized to execute on the computing device 120a only if: (1) the registration server 150 finds a matching registration record; and (2) the computing device ID of that registration record matches the computing device ID of the authorization request 164.

The computing device 120a receives the authorization response 168 (FIG. 2, operation 274) and determines whether the response 168 indicates that the application instance 104a′ is authorized to execute on the computing device 120a (FIG. 2, operation 276). If the computing device 120a determines that the response 168 indicates that the application instance 104a′ is not authorized to execute on the computing device 120a, then the computing device 120a prevents the application instance 104a′ from executing on the computing device 120a (FIG. 2B, operation 278), such as by terminating execution of the application instance 104a′ if it is already executing on the computing device 120a and/or by preventing the application instance 104a′ from connecting to an application server (e.g., a multiplayer online videogame server if the application instance 104a′ is a client application for a multiplayer online videogame).

Conversely, if the computing device 120a determines that the response 168 indicates that the application instance 104a′ is authorized to execute on the computing device 120a, then the computing device 120a allows the application instance 104a′ to execute on the computing device 120a (FIG. 2B, operation 280), such as by performing any one or more of the following: executing the application instance 104a′, providing the user 130a with access to some or all features of the application instance 104a′, and allowing the application instance 104a′ to connect to an application server (e.g., a multiplayer online videogame server if the application instance 104a′ is a client application for a multiplayer online videogame).

In summary, the systems and methods of FIGS. 1A-1B and 2A-2B may be used to enable a user to install and register an instance of a software application to a particular computing device and to execute that registered software application instance from the particular computing device to which the software application instance was registered. Examples of techniques that may be used to enable a copy of a registered software application instance to be executed on a computing device (the “streaming computing device”) other than the computing device to which the software application instance is registered, and for the streaming computing device to stream the executed software application instance to one or more other computing devices.

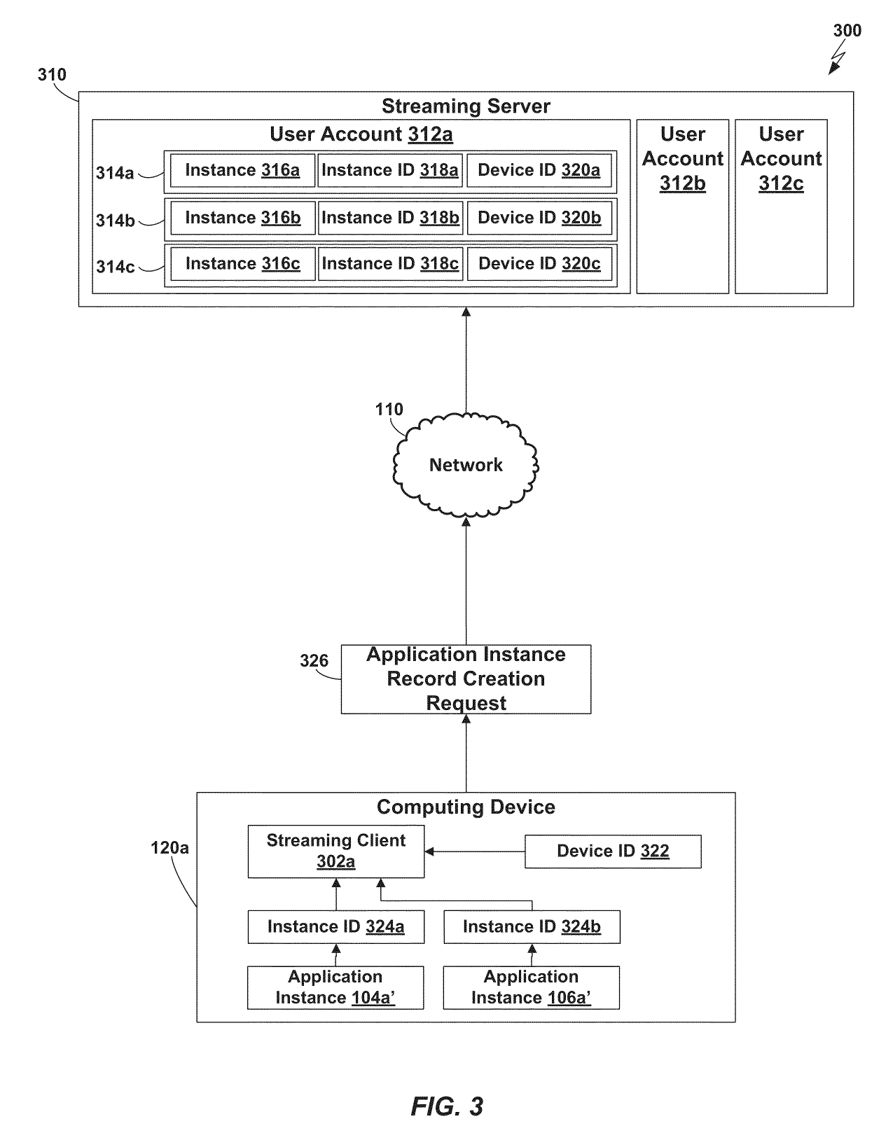

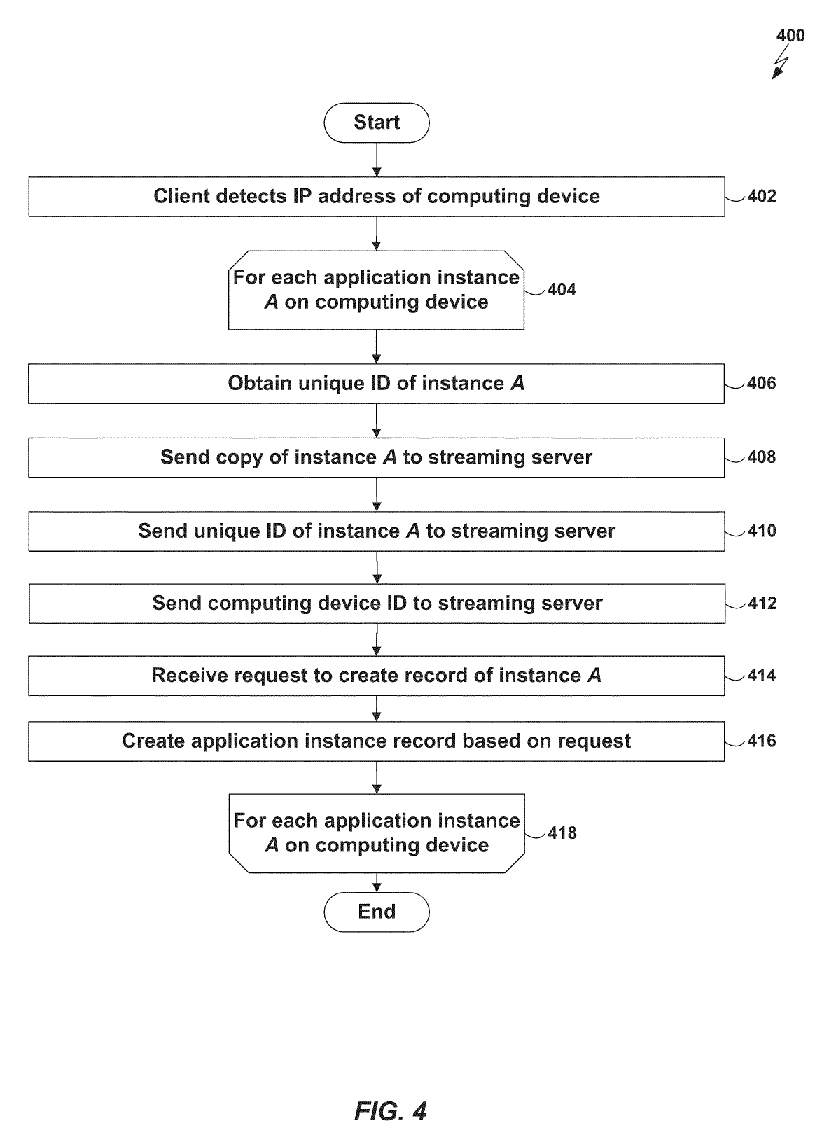

Referring to FIG. 3, a dataflow diagram is shown of a system 300 for streaming an application instance to one or more computing devices according to one embodiment of the present invention. Referring to FIG. 4, a flowchart is shown of a method 400 performed by the system 300 of FIG. 3 according to one embodiment of the present invention.

In the system 300 of FIG. 3, the computing device 120a has been modified to include a streaming client 302a. The streaming client 302a may, for example, be a software application for performing the functions disclosed herein. Similarly, the computing devices 120b and 120c have been modified to include streaming clients 302b and 302c, respectively. Any description of the streaming client 302a herein is equally applicable to the streaming clients 302b and 302c.

The system 300 also includes a streaming server 310. The streaming server 310 may include a plurality of user accounts 312a-c. Although three user accounts 312a-c are shown in FIG. 3 for purposes of example, the streaming server 310 may include any number of user accounts. In general, each of the user accounts 312a-c corresponds to a distinct user of the system 300. For example, assume that user account data 312a corresponds to user 130a, that user account data 312b corresponds to user 130b, and that user account data 312c corresponds to user 130c. In general, each of the user accounts 312a-c contains: (1) data indicating which application instances each of the users 130a-c of the system 300 is authorized to execute; and (2) data enabling the server 310 to execute each such application instance on behalf of the corresponding user.

The user account data 312a-c may be created and modified in any of a variety of ways. For example, each of the users 130a-c may begin the process of creating a corresponding one of the accounts 312a-c in any of a variety of ways, such as any conventional manner for creating an online user account, such as navigating a web browser to a URL associated with the streaming server 310, issuing an instruction to create a new account, providing account credentials (e.g., a username and password), and providing payment information. In response, the streaming server 310 may create a new user account.

The user 130a may execute the streaming client 302a-c on computing devices 120a-c in any of a variety of ways. For example, some or all of the streaming clients 302a-c may be configured to execute automatically upon startup of the respective computing devices 120a-c. As a result, the clients 302a-c may execute automatically, without requiring them to be executed by the user 130a. As another example, the user 130a may execute one or more of the clients 302a-c manually in any known manner, such as by double-clicking on an icon or other visual representation of the client.

The following operations of FIG. 4 will be described as being performed by streaming client 302a. It should be understood that any streaming clients disclosed herein (e.g., streaming clients 302b-c) may also perform the operations of FIG. 4.

The streaming client 302a detects a unique ID 322 (e.g., IP address and/or MAC address) of the computing device 120a on which the streaming client 302a is executing (FIG. 4, operation 402). The unique ID 322 may be of the same type as the unique IDs 156a-c that are stored in the registration records 152a-c on the registration server 150. For example, if the unique IDs 156a-c represent IP addresses, then the unique ID 322 detected by the streaming client 302a may be an IP address of the computing device 120a.

For each registered application instance A installed on the computing device 120a, the streaming client 302a may perform a variety of operations (FIG. 4, operation 404). The streaming client 302a may obtain a unique ID (e.g., license key) of the application instance A (FIG. 4, operation 406). For example, as shown in FIG. 3, if the application instance A is application instance 104a′, then the streaming client 302a may obtain a unique ID 324a of the application instance 104a′. Similarly, if the application instance A is application instance 106a′, then the streaming client 302a may obtain a unique ID 324b of the application instance 106a′.

The unique IDs 324a-b may be of the same type as the unique IDs that are stored in the application instance data 154a-c in the registration records 152a-c on the registration server 150. For example, if the application instance data 154a-c contain license keys, then the unique IDs 324a-b obtained by the streaming client 302a may also be license keys of application instances 104a′ and 106a′.

The streaming client 302a may send, to the streaming server 310 over the network 110, a request 326 to create an application instance record at the streaming server 310. The request 326 may include, for example, one or more of the following:
a copy of the application instance A (e.g., application instance 104a′) (FIG. 4, operation 408);
the unique application instance ID detected in operation 406 (e.g., unique application instance ID 324a) (FIG. 4, operation 410); and
the unique computing device ID detected in operation 402 (e.g., unique computing device ID 322) (FIG. 4, operation 412).

In response to receiving the request 326 (FIG. 4, operation 414), the streaming server 310 creates a new application instance record based on the request 326 (FIG. 4, operation 416). For example, assuming that the request 326 specifies the application instance 104a′ and corresponding unique application instance ID 324a, the streaming server 310 may create application instance record 314a, which contains a copy 316a of the application instance 104a′, an application instance unique ID 318a which is equivalent to the application instance unique ID 324a, and a computing device unique ID 320a which is equivalent to the computing device unique ID 322. In this way, the application instance record 314a contains data sufficient to enable the streaming server 310 to execute and stream the application instance copy 316a, as will be described in more detail below.

The streaming server 310 may deny the request 326 in some circumstances. For example, the streaming server 310 may identify a platform on which the application instance A specified by the request 326 is designed to execute. The streaming server 310 may also identify the platform of the streaming server 310. The streaming server 310 may determine whether the platform on which the application instance A is designed to execute is the same as the platform of the streaming server 310. The streaming server 310 may grant the request 326 if the platform on which the application instance A is designed to execute is the same as the platform of the streaming server 310, and deny the request 326 if the platform on which the application instance A is designed to execute is not the same as the platform of the streaming server 310. As one particular example, the streaming server 326 may deny the request if the application A is designed to execute on the Windows 8 platform and the platform of the streaming server 310 is the PlayStation 3. If the streaming server 310 denies the request 326 for a particular application A, the streaming server 310 may not create an application instance record for application A (FIG. 4, operation 416).

The method 400 repeats operations 406-416 for the remaining application instances installed on the computing device 120a (FIG. 4, operation 418). For example, by repeating operations 406-416 for application instance 106a′, the method 400 may cause the system 300 to create application instance record 314b, which contains a copy 316b of application instance 106a′, an application instance unique ID 318b which is equivalent to the application instance unique ID 324b, and a computing device unique ID 320b which is equivalent to the computing device unique ID 322.

As described above, some or all of the streaming clients 302a-c may perform the method 400. In the example of FIG. 3, the user account 312a contains an application instance record 314c corresponding to an application instance installed on second computing device 120b. In particular, the application instance record 314c contains a copy 316c of an application instance installed on computing device 120b, an application instance unique ID 318c which is equivalent to the unique ID of the application executing on the second computing device 120b, and a computing device unique ID 320c which is equivalent to a unique ID (e.g., IP address and/or MAC address) of the second computing device 120b. As this example illustrates, the user account 312a for user 130a may include application instance records corresponding to application instances installed on disparate computers having disparate unique IDs (e.g., IP addresses and/or MAC addresses).

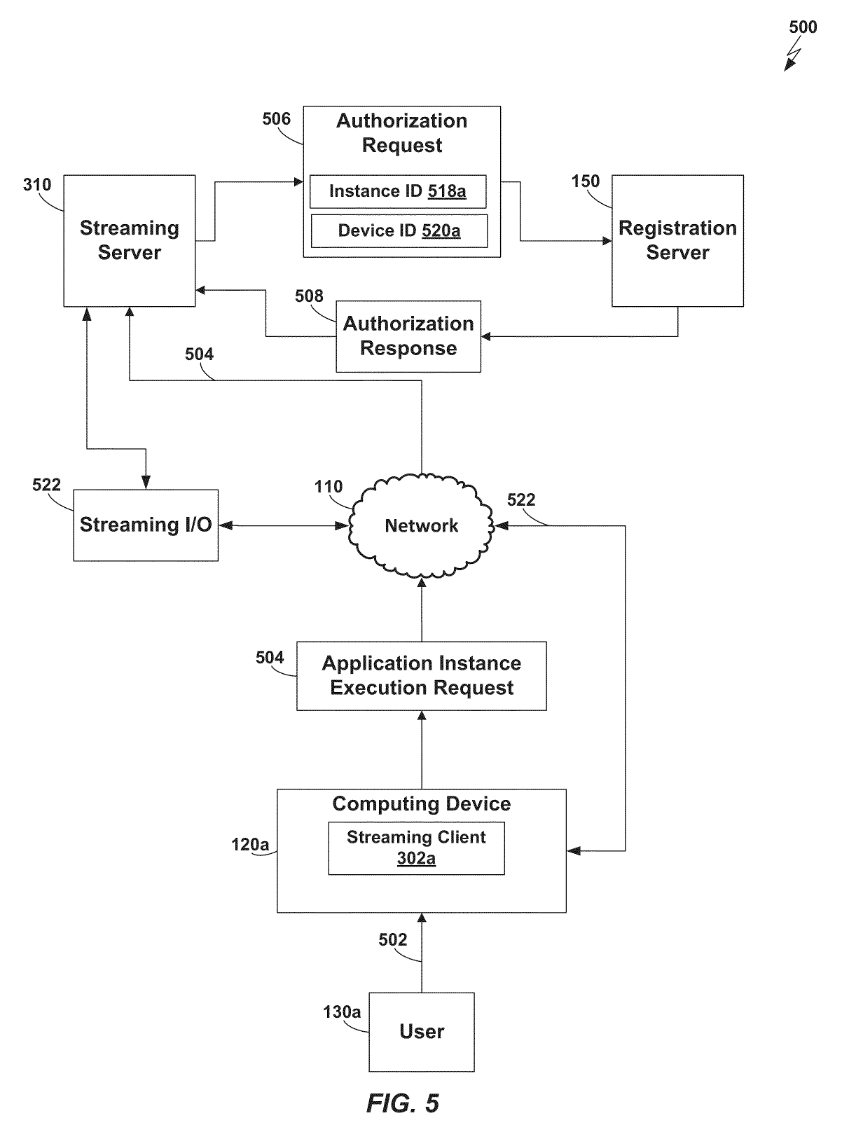

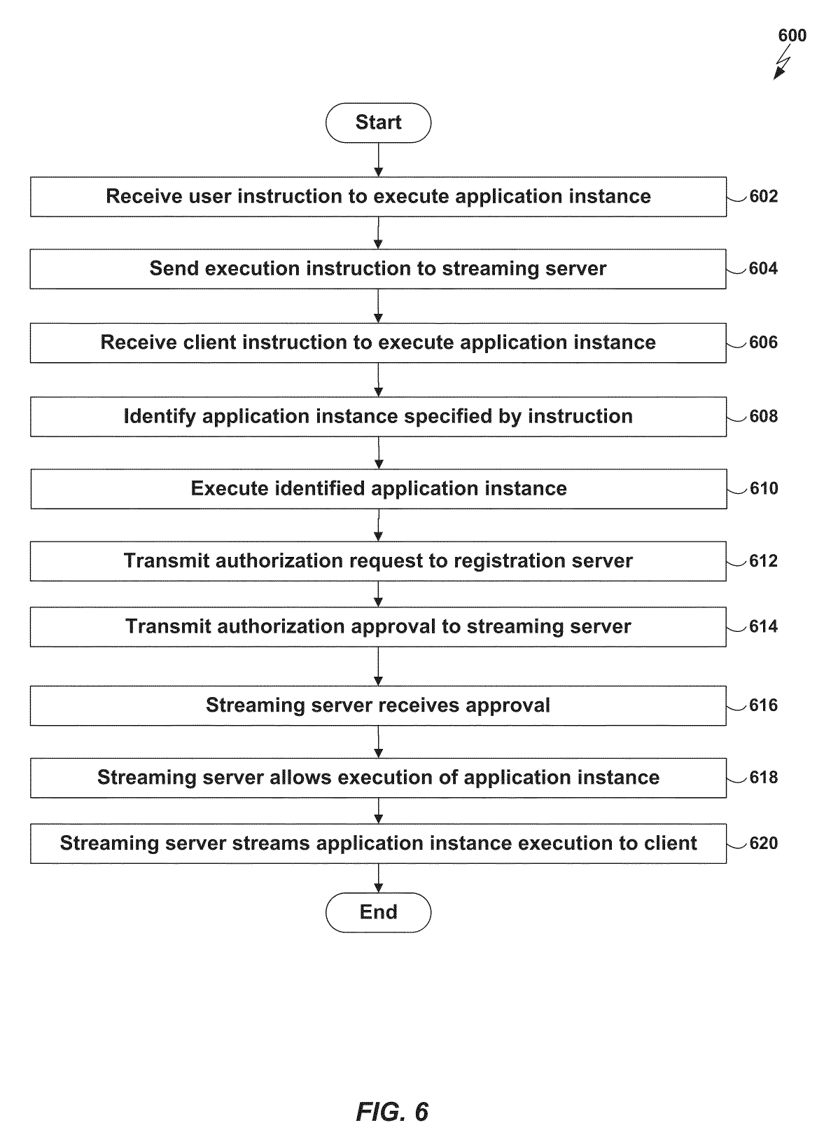

Once a user has created an account on the streaming server 310, the user may use the streaming server 310 to execute one or more application instances associated with the user's account on the streaming server, and to stream such executing application instances to one or more of the user's computing devices. Referring to FIG. 5, a dataflow diagram is shown of a system 500 for streaming application instances from the streaming server 310 to one or more computing devices according to one embodiment of the present invention. Referring to FIG. 6, a flowchart is shown of a method 600 performed by the system 500 of FIG. 5 according to one embodiment of the present invention.

As mentioned above, the streaming clients 302a-c may execute on the computing devices 120a-c, respectively. Furthermore, the streaming clients 302a-c may log in to the user's account 312a on the streaming server 310 in any of a variety of ways. For example, each of the streaming clients 302a-c may store the login credentials for the user account 312a, and automatically log in to the user account 312a using such stored credentials. As another example, the streaming clients 302a-c may prompt the user 130a for the user's login credentials, in response to which the user 130a may provide the login credentials to the streaming clients 302a-c, in response to which the streaming clients 302a-c may log in to the user 130a's account 312a. The following description will assume that the streaming clients 302a-c are logged in to the user's account 312a or otherwise have access to the user's account 312a.

The user 130a provides an instruction 502 to one of the streaming clients 302a-c to execute one of the application instances associated with the user 130a's account 312a (FIG. 6, operation 602). The instruction 502, in other words, includes data specifying a particular one of the application instances 316a-c associated with the user's account 312a. In the particular example shown in FIG. 5, the user 130a provides the instruction 502 to streaming client 302a. Assume, for purposes of example, that the instruction 502 includes data specifying application instance 316a. In this particular example, the instruction 502 is an instruction to execute an application instance (i.e., application instance 316a) that is a copy of or otherwise equivalent to an application instance (i.e., application instance 104a′) that is registered to the same computing device as the computing device that issued the instruction 502 (i.e., computing device 130a).

This is merely an example, however, and does not constitute a limitation of the present invention. Alternatively, for example, the computing device that issues the instruction 502 may be a computing device other than the computing device to which the application instance (or a copy thereof) specified by the instruction 502 is registered. As a further example, the computing device that issues the application instance specified by the instruction 502 may not be installed on the computing device that issues the instruction 502. As a particular example, consider the case in which the computing device 130a issues an instruction to execute application instance 316c, which is a copy of an application instance that is: (1) installed on and registered to computing device 120b; and (2) is neither installed on nor registered to computing device 120a, which issued the instruction 502.

The streaming client 302a sends an instruction 504 over the network 110 to the streaming server 310 to execute the application instance specified by the instruction 502 (FIG. 6, operation 604). The instruction 504 may be a copy of or otherwise equivalent to instruction 502. The server 310 receives the instruction 504.

In response to receiving the instruction 504, the streaming server identifies the application instance specified by the instruction 504 (e.g., application instance 316a) and executes the identified application instance on the streaming server 310 (FIG. 6, operation 610).

As described above with respect to FIGS. 1B and 2B, when a computing device attempts to execute a software application instance (or a copy thereof), the software application instance may contact a corresponding registration server to authenticate the software application instance, and the software application instance may be prohibited from executing if the registration server determines that the request to execute the software application instance was received by the registration server from a computing device other than the computing device to which the software application instance is registered.

To overcome this problem and enable the application instance 316a to execute on the streaming server 310, even though the streaming server 310 is not the computing device 120a to which the application instance 316a is registered, the server 310 may mimic, when executing the application instance 316a, the unique ID (e.g., IP address and/or MAC address) of the computing device to which the application instance 316a is registered (e.g., the IP address and/or MAC address specified by the unique computing device ID 320a of the record 314a containing the application instance 316a). As a result, if the application instance 316a requests or otherwise attempts to obtain the unique ID (e.g., IP address and/or MAC address) of the computing device on which the application instance 316a is executing, the streaming server 310 will provide the unique ID 320a of the computing device 120a to which the application instance 316a is registered in response to such a request, rather than the unique ID (e.g., IP address and/or MAC address) of the streaming server 310, even though the application instance 316a is installed on the streaming server 310. As this implies, if multiple application instances are executing on the streaming server 310 contemporaneously, then the streaming server 310 may contemporaneously mimic different unique IDs (e.g., IP addresses and/or MAC addresses) for two or more of such executing application instances.

Now assume that the application instance 316a transmits an authorization request 506 to the registration server 150 associated with the application instance 316a, to request authorization for the application instance 316a to execute on the streaming server 310 (FIG. 6, operation 612). The application instance 316a may generate and transmit the authorization request 506 in the same manner as that described above for the authorization request 164 of FIG. 1B. The authorization request 506 may, therefore, include a unique application instance ID 518a and a unique computing device ID 520a. The unique application instance ID 518a may, for example, be a copy of the unique application instance ID 318a. Similarly, the unique computing device ID 520a may, for example, be a copy of the unique computing device ID 320a, namely the unique computing device ID of the computing device 120a to which the application instance 316a is registered, rather than the unique computing device ID of the streaming server.

As a result, when the registration server 150 receives the authorization request 506 and determines whether to approve the authorization request 506 using the techniques of FIGS. 1B and 2B, the registration server 150 will approve the authorization request 506 because the unique application instance ID 518a and the unique computing device ID 520a in the authorization request 506 will match the unique computing device ID and the unique computing device ID in the registration record 152a associated with the application instance 316a. As a result, the registration server 150 will transmit an authorization response 508 over the network 110 to the streaming server 310 (FIG. 6, operation 614), even though the streaming server 310 is not the computing device 120a to which the application instance 316a is registered. The streaming server 310 therefore receives the approval 508 (FIG. 6, operation 616) and allows the application instance 316a to execute on the streaming server 310 (FIG. 6, operation 618).

The streaming server 310 streams the executing application instance 316a to the streaming client 302a (FIG. 6, operation 620). In general, streaming the application involves exchanging streaming input/output 522 between the streaming server 310 and streaming client 302a. The streaming I/O 522 may be exchanged in any of a variety of well-known ways. In general, the input portion of the streaming I/O 522 represents input provided by the computing device 120a (e.g., user input) to the application instance 316a, and the output portion of the streaming I/O 522 represents output provided by the application instance 316a to the computing device 120a (such as visual and/or auditory output).

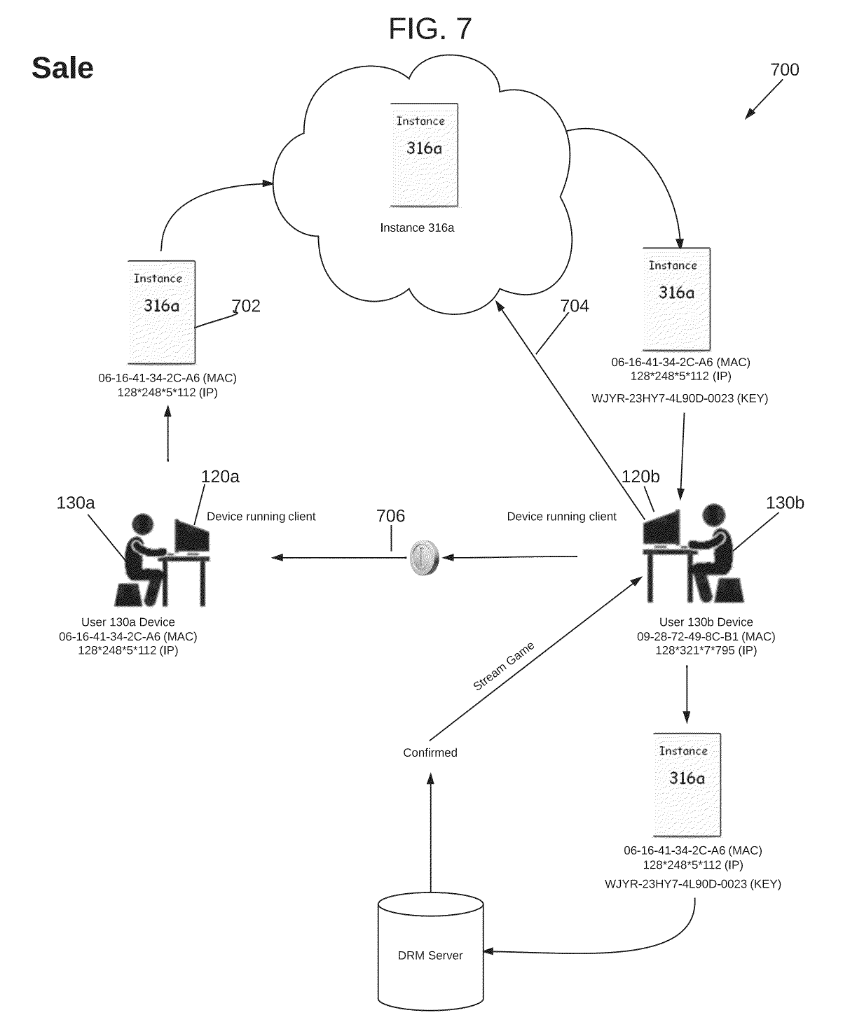

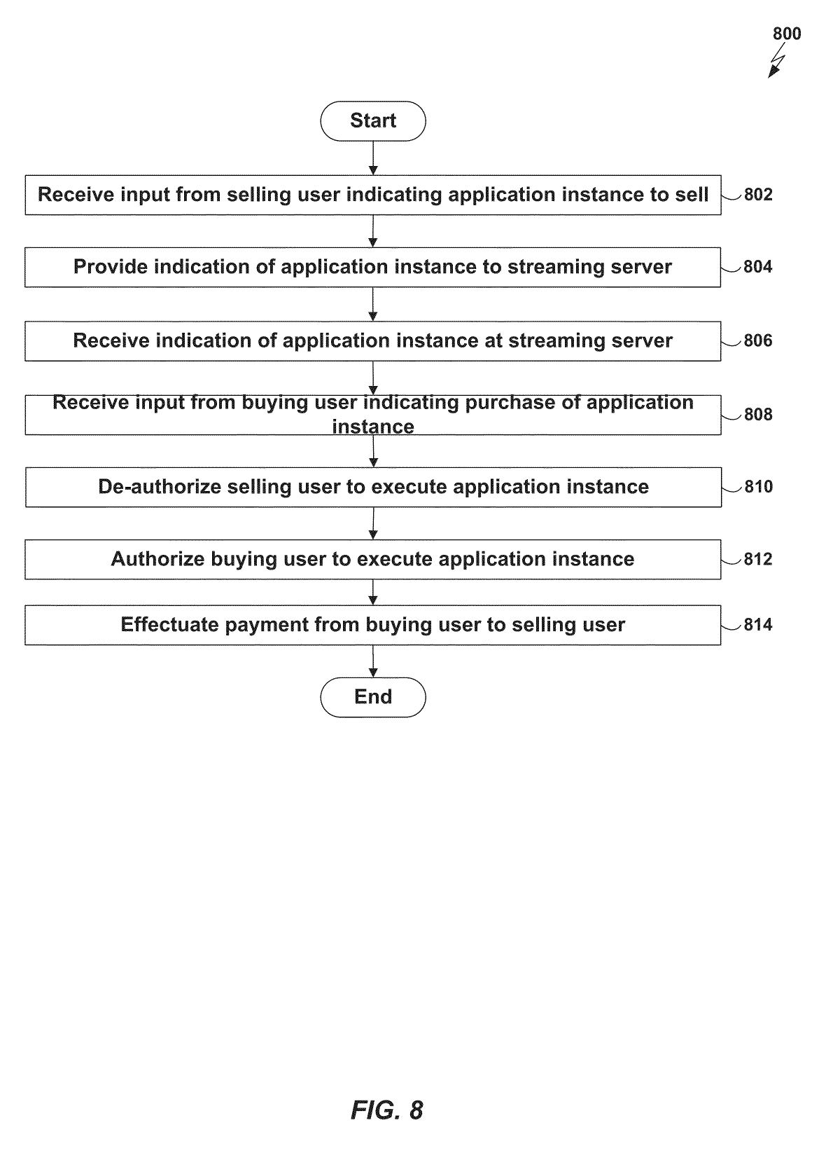

Embodiments of the present invention may be used to enable users to exchange (e.g., sell, swap, and/or switch) application instances. The sale of an application instance by a first User A to a second User B involves the transfer of ownership rights from User A to User B and the transfer of payment from User B to user A. Referring to FIG. 7, a dataflow diagram is shown of a system 700 for enabling one user to sell an application instance to a second user according to one embodiment of the present invention. Referring to FIG. 8, a flowchart is shown of a method 800 performed by the system 700 of FIG. 7 according to one embodiment of the present invention.

In the example of FIG. 7, user 130a desires to sell a particular application instance in user 130a's account 312a. Assume for purposes of example that this is application instance 316a. The first user 130a will be referred to as the “selling user” in the context of FIGS. 7 and 8. Further assume that user 130b wishes to purchase the application instance 316a being sold by selling user 130a. The second user 130b, therefore, will be referred to as the “buying user” in the context of FIGS. 7 and 8.

The selling user 130a provides input 702 specifying the application instance 316a to sell (FIG. 8, operation 802). The input 702 may contain additional information, such as a description and/or asking price for the application instance 316a. The selling user 130a's streaming client 302a transmits the input 702 to the streaming server 310 (FIG. 7, operation 804), which receives the input 702 (FIG. 7, operation 806). The streaming server 310 may make other users (e.g., users 130b-c) aware that the application instance 316a is available for sale in any of a variety of ways, such as by listing the application instance 316a for sale on a web site which displays information about the application instance 316a, such as its name, cover art, and information from the input 702 (e.g., description and/or asking price).

The system 700 receives input 704 from the buying user 130b indicating that the buying user 130b desires to purchase the application instance 316a (FIG. 8, operation 808). Although input 704 is shown in simplified form in FIG. 8, such input may be provided by the user 130b to the streaming client 302b on computing device 120b, which may then provide input 704 to the streaming server 310. The input 704 may include both a request to purchase the application instance 316a and authorization to make payment using any suitable payment process (e.g., credit card, ACH transfer, or virtual currency).

In response to receiving the input 704, the streaming server 310 may:
Remove the selling user 130a's authorization to execute the application instance 316a (FIG. 8, operation 810). This may involve, for example, any one or more of the following: removing the application instance record 314a from the selling user 130a's account 312a, setting a status of the application instance record 314a to “transferred” or to another status which does not provide the selling user 130a the authority to execute the application instance 316a, and retiring the application instance ID 318a. Retiring the application instance ID 318a may include, for example, deleting and/or otherwise inactivating any one or more of the following: the application ID 144a, the instance ID 144b, and the device ID 144c within the registration server 150 and/or the user accounts 312a-c of the streaming server 310. Retiring the application instance ID 318a may be useful in preventing piracy of applications. If a user attempts to re-upload a retired application instance to the streaming server 310, the streaming server 310 will recognize that the application instance is retired and prevent the user from re-uploading the application instance to the streaming server 310.
Transfer the application instance record 314a of the application instance 316a to the buying user's account 312b, or otherwise modify the buying user's account 312b to provide the buying user 130b with authority to execute the application instance 316a (FIG. 8, operation 812).
Effectuate payment 706 of the purchase price from the buying user 130b to the selling user 130a (FIG. 8, operation 814). Such payment 706 may be effectuated by, for example, transferring the payment 706 from the buying user 130b to the selling user 130a, or by causing an external payment system (not shown) to transfer the payment 706 from the buying user 130b to the selling user 130a.

As a result of performing the method 800, ownership of the application instance 316a has been transferred from the selling user 130a to the buying user 130b. As a result, the selling user 130a is no longer able to use the streaming server 310 to execute or stream the application instance 316a, and any of the techniques disclosed herein may be used to enable the streaming server 310 to stream the application instance 316a to any one or more of the buying user 130b's computing devices.

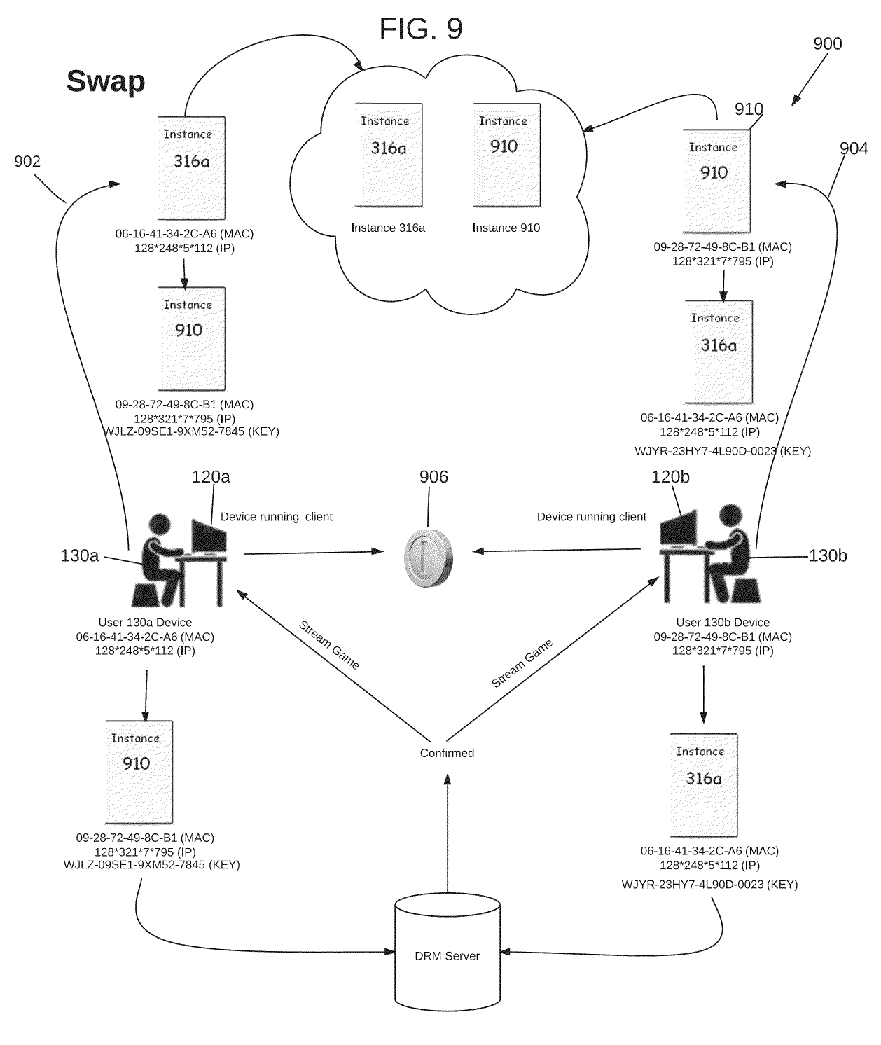

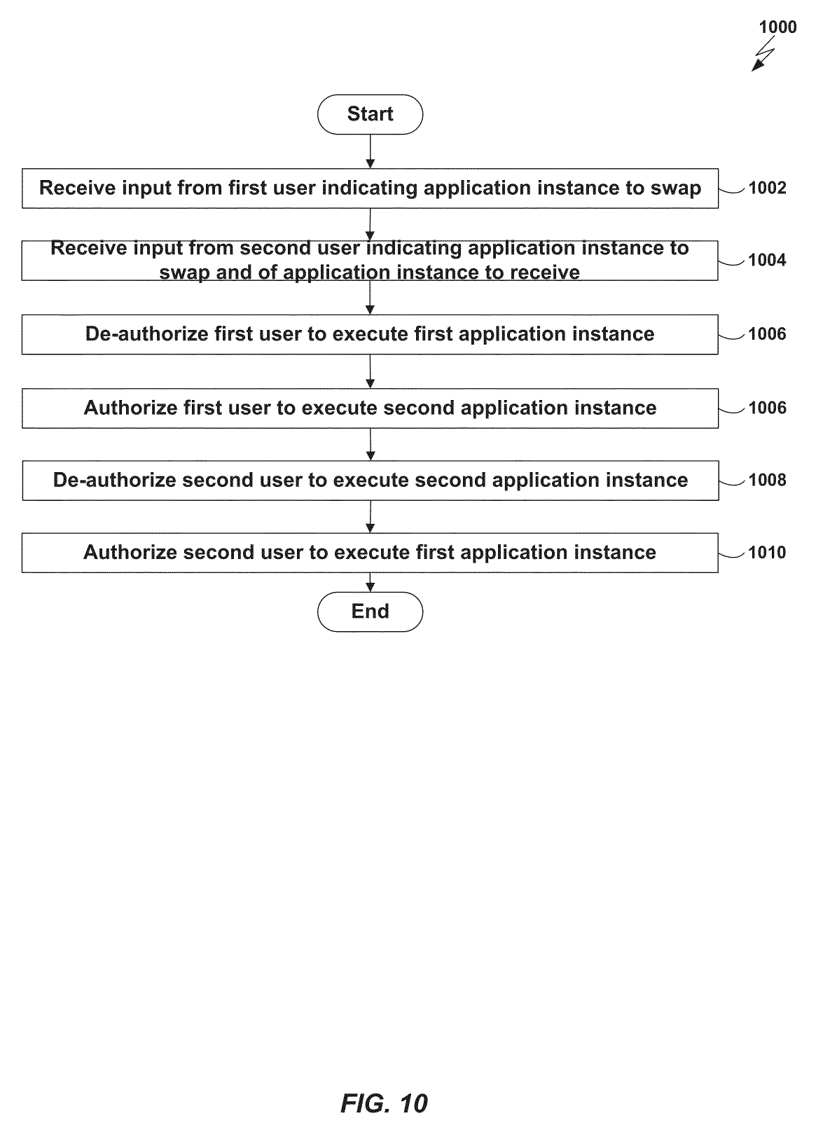

Referring to FIG. 9, a dataflow diagram is shown of a system 700 for enabling one user to swap a first application instance with a second user in exchange for a second application instance according to one embodiment of the present invention. Referring to FIG. 10, a flowchart is shown of a method 1000 performed by the system 900 of FIG. 9 according to one embodiment of the present invention. In general, swapping the first application involves transferring ownership of the first application from the first user to the second user and transferring ownership of the second application from the second user to the first user. For example, a swap may be effectuated by applying the techniques of FIGS. 7-8 to transfer ownership of the first application from the first user to the second user and to transfer ownership of the second application from the second user to the first user, but without requiring payment from either user to the other.

The selling user 130a provides input 902 specifying the application instance 316a to make available for a swap (FIG. 10, operation 1002). The input 1002 may take any of the forms described above for input 702, and any of the techniques disclosed above in connection with input 702 may be applied to input 902. The input 1002 may further specify one or more applications, instances of which the selling user 130a is willing to accept in exchange for the application instance 316a.

The system 900 receives input 904 from the buying user 130b indicating that the buying user 130b desires to swap the application instance 316a for an application instance 910 in the account of buying user 130b (FIG. 10, operation 1004). The input 904 may take any of the forms described above for input 704, and any of the techniques disclosed above in connection with input 704 may be applied to input 904, except that the input 704 may, but need not, include payment information.

If the selling user 130a specified (via input 1002) that the selling user 130a would only accept an instance of one or more particular applications in exchange for the application instance 316a, then the streaming server 310 may determine, in response to receiving the input 904, whether the buying user 130b's input indicates that the application instance 910 is an instance of one of the applications specified by the selling user 130a's input. If the buying user 130b's application instance 910 is not an instance of one of the applications specified by the selling user 130a's input, then the streaming server 310 may terminate the transaction, in which case the remainder of the method 1000 of FIG. 10 may not be performed. The remaining discussion of FIGS. 9 and 10 assumes either that the selling user 130a did not require the buying user 130b's application instance 910 to satisfy any requirements or that such requirements have been satisfied.

In response to receiving the input 904, the streaming server 310 may:
Remove the first user 130a's authorization to execute the application instance 316a in any of the ways disclosed above with respect to FIGS. 7-8 (FIG. 10, operation 1006).
Authorize the first user 130a to execute the application instance 910 in any of the ways disclosed above with respect to FIGS. 7-8 (FIG. 10, operation 1008).
Remove the second user 130b's authorization to execute the application instance 910 in any of the ways disclosed above with respect to FIGS. 7-8 (FIG. 10, operation 1010).
Authorize the second user 130b to execute the application instance 316a in any of the ways disclosed above with respect to FIGS. 7-8 (FIG. 10, operation 1012).

Although payment is not always required for a swap, in some cases payment may be required from one of the two users 130a-b to the other. For example, the system 900 may assign values to the application instances 316a and 910. If the value of the application instance 316a is higher than the value of the application instance 910, then the system 900 may require and effectuate payment 906 of the difference in value from the second user 130b to the first user 130a. Conversely, if the value of the application instance 316a is lower than the value of the application instance 910, then the system 900 may require and effectuate payment 906 of the difference in value from the first user 130a to the second user 130b.

As a result of performing the method 1000, ownership of the application instance 316a has been transferred from the first user 130a to the second user 130b, and ownership of the application instance 910 has been transferred from the second user 130b to the first user 130a. As a result:
the first user 130a is no longer able to use the streaming server 310 to execute or stream the application instance 316a;
the second user 130b is able to use the streaming server 310 to execute and/or stream the application instance 316a to any one or more of the second user 130b's computing devices;
the second user 130b is no longer able to use the streaming server 310 to execute or stream the application instance 910; and
the first user 130a is able to use the streaming server 310 to execute and/or stream the application instance 910 to any one or more of the first user 130a's computing devices.

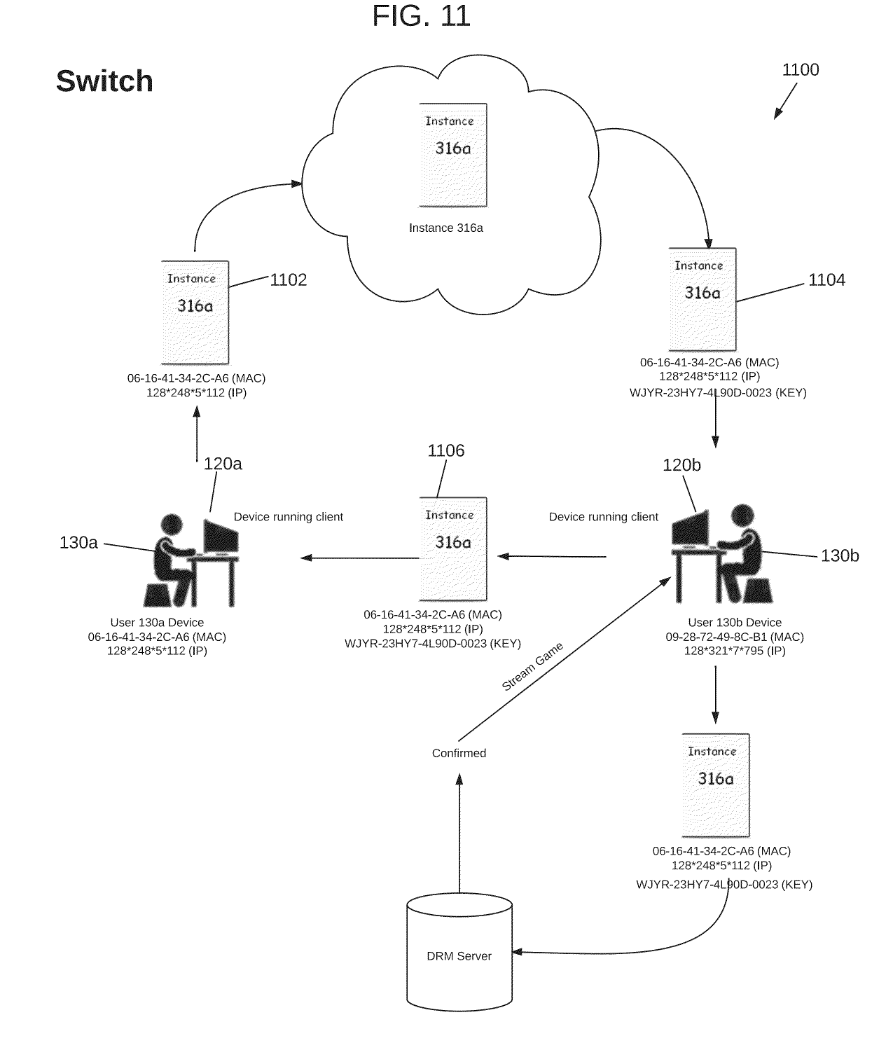

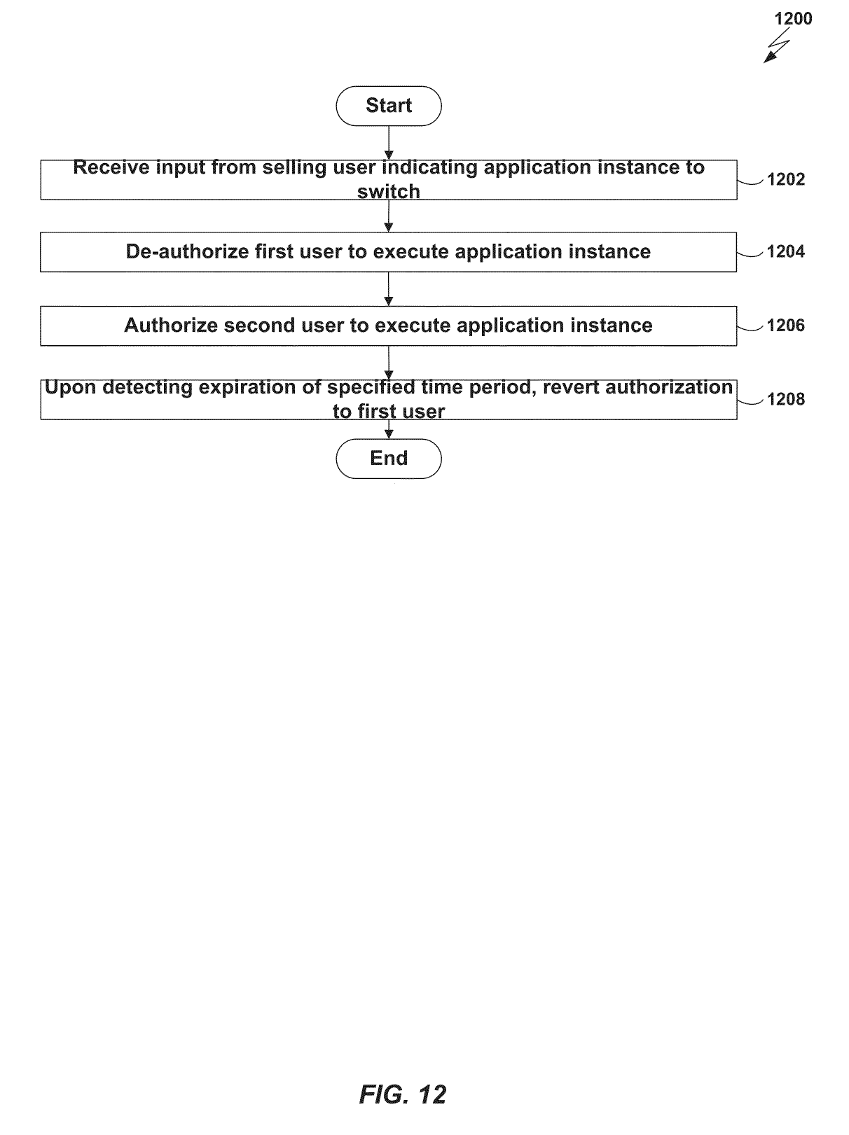

Referring to FIG. 11, a dataflow diagram is shown of a system 1100 for enabling one user to switch an application instance to a second user according to one embodiment of the present invention. Referring to FIG. 12, a flowchart is shown of a method 1200 performed by the system 1100 of FIG. 11 according to one embodiment of the present invention.

In the example of FIG. 11, user 130a desires to switch a particular application instance in user 130a's account 312a to the account 312b of user 130b. “Switching” an application instance from a first user to a second user refers to temporarily transferring ownership and/or usage rights in the application instance from the first user to the second user for a particular time period, and reverting the ownership and/or usage rights in the application instance from the second user to the first user upon the expiration of the particular time period. Assume for purposes of example that this is application instance 316a.

The first user 130a provides input 1102 specifying the application instance 316a to switch (FIG. 12, operation 1202). The input 1102 may take any of the forms described above for input 702, and any of the techniques disclosed above in connection with input 702 may be applied to input 1102. The input 1102 may also include data representing a time period (e.g., one hour, one day, or one week) associated with the switch.

In response to receiving the input 1104, the streaming server 310 may:
Remove the first user 130a's authorization to execute the application instance 316a (FIG. 12, operation 1204). This may involve, for example, any one or more of the following: removing the application instance record 314a from the selling user 130a's account 312a and setting a status of the application instance record 314a to “switched” or to another status which does not provide the first user 130a the authority to execute the application instance 316a.
Transfer the application instance record 314a of the application instance 316a to the second user's account 312b, or otherwise modify the second user's account 312b to provide the second user 130b with authority to execute the application instance 316a (FIG. 12, operation 1206).
As a result of performing the operations described above, ownership and/or usage rights in the application instance 316a are temporarily transferred from the first user 130a to the second user 130b. As a result, the first user 130a is not able to use the streaming server 310 to execute or stream the application instance 316a during the time period specified by the first user 130a, and any of the techniques disclosed herein may be used to enable the streaming server 310 to stream the application instance 316a to any one or more of the second user 130b's computing devices during the time period specified by the first user 130a.

Upon expiration of the time period specified by the first user 130a, the streaming server 310 reverts 1106 ownership and/or usage rights in the application instance 316a from the second user 130b to the first user 130a (FIG. 12, operation 1208). Such reversion may be performed, for example, using the techniques of operations 1204-1206, but in the reverse direction. As a result of operation 1208, the second user 130b is not able to use the streaming server 310 to execute or stream the application instance 316a, and any of the techniques disclosed herein may be used to enable the streaming server 310 to stream the application instance 316a to any one or more of the first user 130a's computing devices.

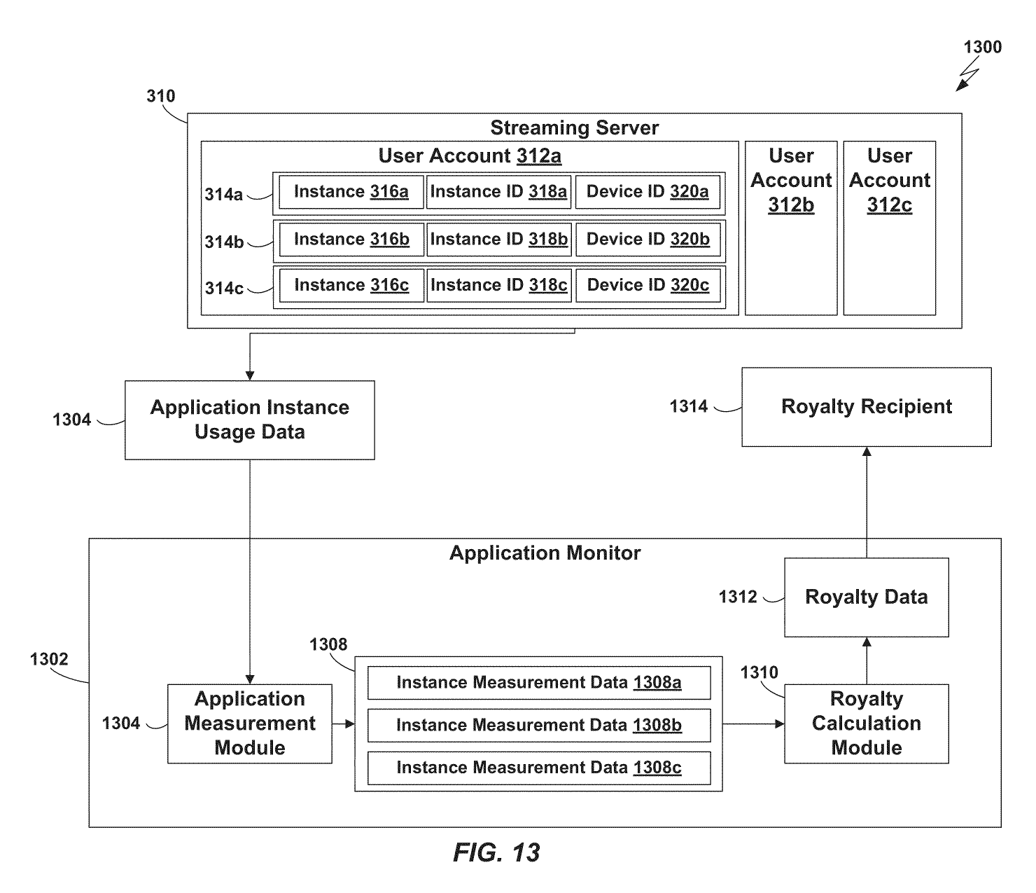

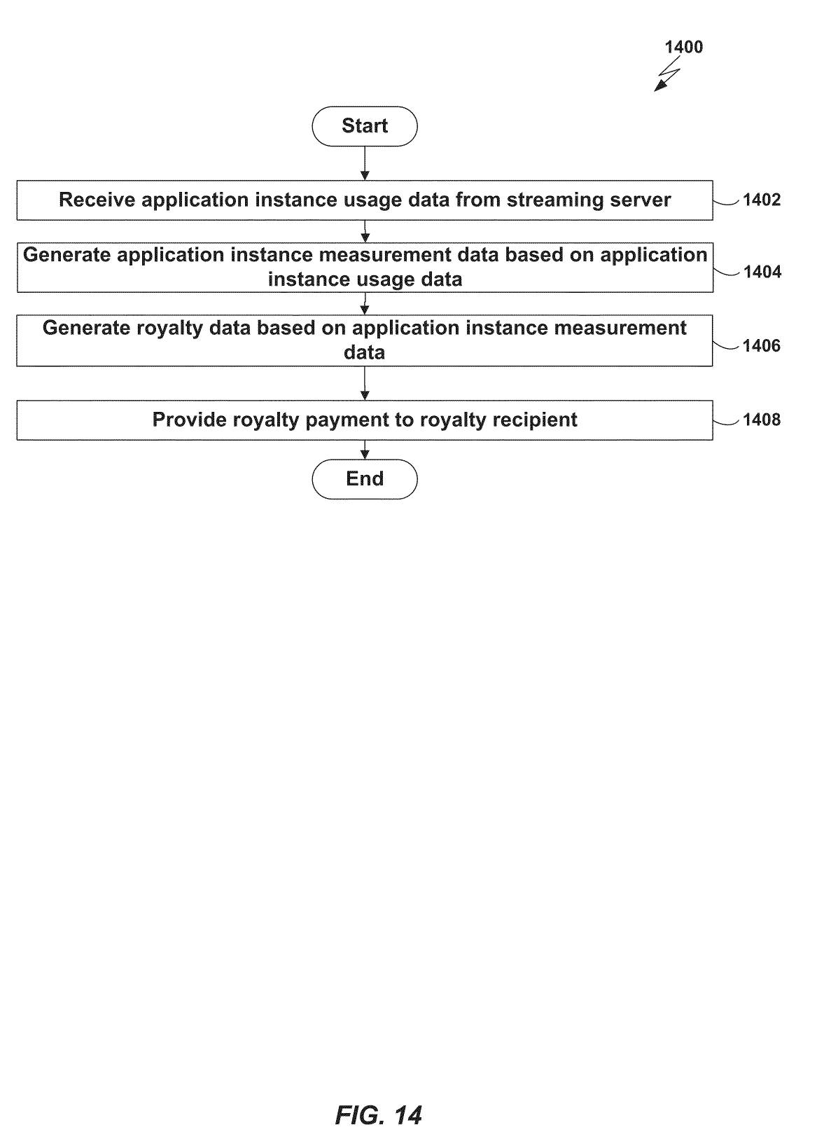

Embodiments of the present invention may be used to monitor and track the amount of time that a particular application instance is executed by a particular user. If the application instance is a videogame, then the amount of time that the application instance is executed by a particular user may represent the user's number of hours of play (HOP) of that videogame. Embodiments of the present invention may use such measurements for any of a variety of purposes, such as for calculating and paying royalties to third parties, such as the publisher of the application instance. For example, referring to FIG. 13, a dataflow diagram is shown of a system 1300 for measuring application instance usage according to one embodiment of the present invention. Referring to FIG. 14, a flowchart is shown of a method 1400 that is performed by the system 1300 of FIG. 13 according to one embodiment of the present invention.

The system 1300 includes the streaming server 310 and an application monitor 1302. In general, the application monitor 1302 may monitor, track, and record a variety of data related to the execution of application instances (e.g., instances 316a-c) by the streaming server 310. For example, the application monitor 1302 may receive, from the streaming server 310, application instance usage data 1304 representing one or more characteristics of usage (i.e., execution) of one or more of application instances by the streaming server 310 (FIG. 14, operation 1402). Although not shown in FIG. 13, the application instance usage data 1304 may be transmitted over a network (such as the network 110). The application instance usage data 1304 may be pushed by the streaming server 310 to the application monitor 1302 and/or pulled by the application monitor 1302 from the streaming server 310. Alternatively, for example, the application monitor 1302 may be integrated into the streaming server 310.

The application instance usage data 1304 may, for example, contain one or more of the following:
data representing whether a particular application instance is executing at a particular time;
a running total of the amount of time a particular application instance has been executed since its execution began;
the user account containing or otherwise associated with a particular executing application instance.

Although only one unit of the application instance usage data 1304 is shown in FIG. 13 for ease of illustration, the application monitor 1304 may receive multiple units of the application instance usage data 1304 over time. For example, the application monitor 1302 may receive a new unit of the application instance usage data 1304 periodically, e.g., every second or every minute. Each such unit may contain any of the data described above. For example, each such unit may indicate which application instances are executing on the streaming server 310 and which user accounts are associated with those application instances.

The application monitor 1302 may generate application instance measurement data 1308 based on the one or more received units of application instance usage data 1304 (FIG. 14, operation 1404). In the example shown in FIG. 13, the application instance measurement data 1308 includes application instance measurement data 1308a, which represents measurements of application instance 316a; application instance measurement data 1308b, which represents measurements of application instance 316b; and application instance measurement data 1308c, which represents measurements of application instance 316c.

Application instance measurement data 1308 may represent any of a variety of measurements. For example, application instance measurement data 1308 may include any one or more of the following:
an amount of time (e.g., seconds, minutes, or hours) that the corresponding application instance 316a has been executed by the user associated with corresponding user account 312a in total and/or in a particular period of time (e.g., one hour, one day, one week, one month, or one year); and
an amount of time (e.g., seconds, minutes, or hours) that the corresponding application instance 316a has been executed in aggregate by all users on the streaming server 310 across all times and/or in a particular period of time (e.g., one hour, one day, one week, one month, or one year).

The application monitor 1302 may further include a royalty calculation module 1310, which generates royalty data 1312 based on the instance measurement data 1308 (FIG. 14, operation 1406). The royalty calculation module 1310 may generate the royalty data 1312 in any of a variety of ways. For example, the royalty calculation module 1310 may calculate, for a particular application instance (e.g., application instance 316a), based on corresponding instance measurement data 1308 (e.g., instance measurement data 1308a), a royalty that is proportional to or otherwise a function of the number of hours for which the particular application instance has been played in total or during a particular period of time (e.g., the preceding hour, day, week, or month), either by a single user or by all users associated with all user accounts 312a-c on the server 310. The royalty data 1312 may include data representing such a calculated royalty.

Additionally or alternatively, the royalty calculation module 1310 may calculate a royalty for a particular application instance (e.g., application instance 316a) that is proportional to or otherwise a function of one or more of the following: the number of times the application instance has been sold, the number of times the application instance has been swapped, and the number of times the application instance has been switched in total or during a particular period of time (e.g., the preceding hour, day, week, or month), either by a single user or by all users associated with all user accounts 312a-c on the server 310. The royalty data 1312 may include data representing such a calculated royalty.

The royalty calculation module 1310 may provide the royalty data 1312, or a payment derived from the royalty data 1312, to a royalty recipient 1314, or otherwise cause a payment in an amount specified by the royalty data 1312 to be made to the royalty recipient 1314 (FIG. 14, operation 1408). The royalty calculation module 1310 may provide the payment to the royalty recipient in any of a variety of ways, such as via wire transfer, paper check, or via any method available from a third-party payment service (e.g., PayPal). The royalty recipient 1314 may, for example, be a publisher of the application instance for which the payment is made.

### Advantages

Embodiments of the present invention have a variety of advantages, such as the following. As mentioned above, conventional software application registration systems are design to prevent users from installing and executing multiple copies of the same application instance on multiple computing devices. Users, however, may have legitimate reasons for making such multiple copies. For example, an authorized user of a particular application instance may wish to execute that application instance from multiple computing devices owned by the user. Computer users in today's environment increasingly use a large number of computing devices at home, at work, while in transit, and elsewhere. The inability to execute a single registered application instance from multiple computing devices, and the concomitant need to install and register multiple instances of the same application on multiple devices, is increasingly inconvenient for today's users. Embodiments of the present invention provide a solution to this problem by enabling a registered user of an instance of a software application to effectively execute that application instance on any Internet-connected computing device to which the user has access, whether or not that computing device is the computing device to which the software application instance is registered. As a result, the user need only to install and register the software application instance once on one computing device. Thereafter, the user may easily effectively execute the application instance on any Internet-connected computing device to which the user has access, without the need to install and/or register the application instance again.

Embodiments of the present invention enable the user to associate software application instances installed on a plurality of computing devices with a single user account associated with the user. Thereafter, the user may effectively execute any software application instance associated with the user's account from any Internet-connected computing device. The user account, therefore, represents a virtual hard drive which effectively contains all of the software application instances that the user has installed on all of his or her computing devices. The user may use the techniques herein to effectively execute any application instance in the virtual hard drive from any Internet-connected computing device, whether or not that application instance is contained on or registered to that computing device. In this way, embodiments of the present invention provide the user with a single convenient virtual storage device for storing and executing all of the user's registered software application instances, without requiring the user to initially install and register those software application instances on a single computing device. Instead, the user may install any individual software application instance on any computing device on which it is convenient for the user to install the software application instance at that moment. Embodiments of the present invention may then use the techniques disclosed herein to automatically consolidate all of the user's registered software application instances into the user's virtual hard drive.

Another benefit of embodiments of the present invention is that they do not require existing software application instances or existing software application registration systems to be modified to work in conjunction with embodiments of the present invention. Instead, embodiments of the present invention may work in conjunction with existing software applications and software application registration processes. For example, as described above, embodiments of the present invention may mimic the unique ID (e.g., IP address and/or MAC address) of a computing device to which an application instance is registered, thereby enabling the application instance to execute on the streaming server 310 even though the application instance is not registered to the streaming server 310 and even though the application instance was not designed to execute on any computing device other than the computing device to which the application instance is registered. This feature of embodiments of the present invention makes it possible to use embodiments of the present invention in conjunction with a wide variety of software applications and software application registration systems.

Another advantage of embodiments of the present invention is that they enable users to exchange (e.g., sell, swap, and switch) software application instances with each other easily. Many software applications, such as videogames, have a relatively short useful life for an individual user. A particular user may, for example play and complete a particular videogame in a week or a month and then lose further interest in that particular videogame. Embodiments of the present invention enable users to exchange videogames and other software applications with each other easily, without having to exchange physical storage media and without having to transmit software, license keys, or any other data to each other. Instead, embodiments of the present invention provide simple, fast, and secure methods for exchanging software application instances among users.

### Broadening Language

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(1) providing, to a registration server, a first request to authorize a first application instance installed on, but not registered to, a first computing device to execute on the first computing device;
(2) receiving, from the registration server, in response to the request, a response authorizing the first application instance to execute on the first computing device; and
(3) executing the first application instance on the first computing device.

2. The method of claim 1, wherein the request comprises an identifier of a computing device other than the first computing device, wherein the first application instance is registered to the computing device other than the first computing device.

3. The method of claim 2, wherein the identifier of the computing device other than the first computing device comprises an Internet Protocol (IP) address of the computing device other than the first computing device.

4. The method of claim 2, wherein the identifier of the computing device other than the first computing device comprises a MAC address of the computing device other than the first computing device.

5. The method of claim 1, further comprising:
(4) receiving, from a second computing device, a second request to execute the first application instance on the first computing device; and
wherein (1) comprising providing the first request in response to receiving the second request.

6. The method of claim 1, wherein (3) is performed before (1).

7. The method of claim 6, wherein (3) comprises mimicking an IP address of a second computing device while executing the first application instance on the first computing device.

8. The method of claim 7, wherein the first application instance is registered to the second computing device.

9. The method of claim 6, wherein (3) comprises mimicking a MAC address of a second computing device while executing the first application instance on the first computing device.

10. The method of claim 1, further comprising:
(4) receiving input from a first user representing an instruction to sell the first application instance;
(5) receiving input from a second user representing an instruction to buy the first application instance;
(6) de-authorizing the first user to execute the first application instance on the first computing device; and
(7) authorizing the second user to execute the first application instance on the first computing device.

11. The method of claim 10, further comprising:
(8) effectuating payment from the second user to the first user.

12. The method of claim 1, further comprising:
(4) receiving input from a first user representing an instruction to swap the first application instance;
(5) receiving input from a second user representing an instruction to swap a second application instance for the first application instance;
(6) de-authorizing the first user to execute the first application instance on the first computing device;
(7) authorizing the second user to execute the application instance on the first computing device;
(8) de-authorizing the second user to execute the second application instance on the first computing device; and
(9) authorizing the first user to execute the second application instance on the first computing device.

13. The method of claim 12, further comprising:
(10) effectuating payment from the second user to the first user.

14. The method of claim 1, further comprising:
(4) receiving input from a first user representing an instruction to switch the first application instance to a second user;
(5) de-authorizing the first user to execute the first application instance on the first computing device;
(6) authorizing the second user to execute the application instance on the first computing device;
(7) detecting expiration of a specified time period;
(8) in response to the detection:
(8)(a) de-authorizing the second user to execute the first application instance on the first computing device; and
(8)(b) authorizing the first user to execute the first application instance on the first computing device.

15. The method of claim 1, further comprising:
(4) calculating an amount of time the first application instance has been executed on the first computing device;
(5) calculating a royalty based on the amount of time; and
(6) causing the royalty to be paid to a royalty recipient.

16. A system comprising at least one non-transitory computer readable medium having computer program instructions stored thereon, wherein the computer program instructions are executable by at least one computer processor to perform a method, the method comprising:
(1) providing, to a registration server, a first request to authorize a first application instance installed on, but not registered to, a first computing device to execute on the first computing device;
(2) receiving, from the registration server, in response to the request, a response authorizing the first application instance to execute on the first computing device; and
(3) executing the first application instance on the first computing device.

17. The system of claim 16, wherein the request comprises an identifier of a computing device other than the first computing device, wherein the first application instance is registered to the computing device other than the first computing device.

18. The system of claim 17, wherein the identifier of the computing device other than the first computing device comprises an Internet Protocol (IP) address of the computing device other than the first computing device.

19. The system of claim 17, wherein the identifier of the computing device other than the first computing device comprises a MAC address of the computing device other than the first computing device.

20. The system of claim 16, wherein the method further comprises:
(4) receiving, from a second computing device, a second request to execute the first application instance on the first computing device; and
wherein (1) comprising providing the first request in response to receiving the second request.

21. The system of claim 16, wherein (3) is performed before (1).

22. The system of claim 21, wherein (3) comprises mimicking an IP address of a second computing device while executing the first application instance on the first computing device.

23. The system of claim 22, wherein the first application instance is registered to the second computing device.

24. The system of claim 21, wherein (3) comprises mimicking a MAC address of a second computing device while executing the first application instance on the first computing device.

25. The system of claim 16, wherein the method further comprises:
(4) receiving input from a first user representing an instruction to sell the first application instance;
(5) receiving input from a second user representing an instruction to buy the first application instance;
(6) de-authorizing the first user to execute the first application instance on the first computing device; and
(7) authorizing the second user to execute the first application instance on the first computing device.

26. The system of claim 25, wherein the method further comprises:
(8) effectuating payment from the second user to the first user.

27. The system of claim 16, wherein the method further comprises:
(4) receiving input from a first user representing an instruction to swap the first application instance;
(5) receiving input from a second user representing an instruction to swap a second application instance for the first application instance;
(6) de-authorizing the first user to execute the first application instance on the first computing device;
(7) authorizing the second user to execute the application instance on the first computing device;
(8) de-authorizing the second user to execute the second application instance on the first computing device; and
(9) authorizing the first user to execute the second application instance on the first computing device.

28. The system of claim 27, wherein the method further comprises:
(10) effectuating payment from the second user to the first user.

29. The system of claim 16, wherein the method further comprises:
(4) receiving input from a first user representing an instruction to switch the first application instance to a second user;
(5) de-authorizing the first user to execute the first application instance on the first computing device;
(6) authorizing the second user to execute the application instance on the first computing device;
(7) detecting expiration of a specified time period;
(8) in response to the detection:
(8) (a) de-authorizing the second user to execute the first application instance on the first computing device; and
(8) (b) authorizing the first user to execute the first application instance on the first computing device.

30. The system of claim 16, wherein the method further comprises:
(4) calculating an amount of time the first application instance has been executed on the first computing device;
(5) calculating a royalty based on the amount of time; and
(6) causing the royalty to be paid to a royalty recipient.
